(19) United States
(12) Patent Application Publication
(10) Pub. No.: US 2018/0270073 A1
(43) Pub. Date: Sep. 20, 2018

(54) METHOD AND APPARATUS FOR CHARGING OPERATIONS IN A COMMUNICATION NETWORK

(71) Applicants: Nimal Gamini SENARATH, Ottawa (CA); Hang ZHANG, Nepean (CA)

(72) Inventors: Nimal Gamini SENARATH, Ottawa (CA); Hang ZHANG, Nepean (CA)

(73) Assignee: Huawei Technologies Co., Ltd., Shenzhen (CN)

(21) Appl. No.: 15/917,016

(22) Filed: Mar. 9, 2018

Related U.S. Application Data
(60) Provisional application No. 62/473,057, filed on Mar. 17, 2017.

(51) Int. Cl. H04L 12/14; H04L 12/813; H04L 12/24

(52) U.S. Cl. CPC H04L 12/1407; H04L 12/1489; H04L 12/1492; H04L 47/20; H04L 12/1439; H04L 12/1421; H04L 12/1428; H04L 12/1435; H04L 41/0893

(57) ABSTRACT

Methods and apparatus for supporting customer charging in 5G networks are provided. Monitoring functions are instantiated at selected network locations for tracking access to network services. The monitoring functions provide charging information for use in customer billing. A customer can enter a service level agreement with a particular customized method of charging for service usage, and the monitoring functions can be customized to provide charging information according to the service level agreement. Charging can vary based on factors such as time of day, network congestion, service traffic characteristics, and geographic location. Charging can be reduced by a customer voluntarily reducing service quality, and/or if access is through a Wi-Fi network. Customers can dynamically control traffic to control charging. Charging rates under high-demand conditions can be negotiated via bidding. User-in-the-loop charging can be performed. Charging options for functions such as VNFaaS functions, data caching, pre-fetching, and context sharing are also provided.

### CROSS-REFERENCE TO RELATED APPLICATIONS

The present disclosure is related to U.S. Provisional Patent Application No. 62/473,057 entitled “Method and Apparatus for Charging Operations in a Communication Network” filed Mar. 17, 2017, the content of which is incorporated herein by reference, inclusive of all filed appendices.

### FIELD OF THE INVENTION

The present invention pertains to the field of communication networks and in particular to a method and apparatus for charging operations in a host communication network.

### BACKGROUND

Existing wireless and mobile networks such as third-generation (3G) and fourth-generation (4G) networks typically address usage based charging by tracking data traffic on a per-user equipment (UE) basis. This collected charging information can then be sent to an accounting system (typically within a management plane, or within an Operation Support Subsystem (OSS)/Business Support Subsystem (BSS)). Typically UE data consumption is charged according to a static set of charging rules. Typically a Mobile Network Operator (MNO), or a Mobile Virtual Network Operator (MVNO) track subscriber data consumption, and then apply billing rules in the OSS/BSS. These billing rules may include a fixed data allocation to be associated with a monthly subscription and charges for overages, a per bit/byte/megabyte (etc.) charge for all data consumed, etc. There may be times of day in which consuming network resources is discounted across the network (e.g. free phone calls or a reduced rate for data consumption during evenings and weekends).

In next generation mobile networks (e.g. so-called Fifth-generation (5G) networks), new network architectures and services to be offered are expected to differ in a variety of ways from previous generations of mobile networks. For example, 5G networks may utilize technologies such as network slicing and network function virtualization to dynamically provide customized virtual networks. A Network Operator in a 5G deployment may not be the entity that has a billing relationship with the subscribers, and it may not necessarily own the infrastructure through which a device such as an electronic device, mobile device or UE (terms that will be largely used interchangeably) connects. Particular end user groups may also commission and use customized virtual networks for their own members. The network operator providing the network services to such a virtual network may provide the services for a fee.

The document “3GPP TS 32.101; Technical Specification; 3rd Generation Partnership Project; Technical Specification Group Services and System Aspects; Telecommunication management; Principles and high level requirements,” Release 13, V13.0.0, January 2016, establishes and defines the management principles and high-level requirements for the management of public land mobile networks (PLMNs). FIG. 1, which is a reproduction of FIG. 6.1 of the above-mentioned 3GPP document, illustrates a business process model based on the Enhanced Telecom Operations Map®. The document identifies a need for automated processes to support the illustrated vertical end-to-end, customer operations processes of fulfilment, assurance, and billing, as well as operations support and readiness processes. However, billing processes have not been developed which adequately address the particular needs of new network architectures and new service providers.

Accordingly, it may be desirable to develop charging methods and systems which are appropriate to the capabilities and services of next generation mobile networks. Therefore there may be a need for a method and apparatus for charging operations in a communication network that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

It is an object of the present disclosure to obviate or mitigate at least one disadvantage of the prior art.

According to a first broad aspect of the present disclosure, there is disclosed a monitoring function comprising a processor and a non-transient memory. The non-transient memory is for storing instructions that, when executed by the processor, cause the monitoring function to actions of: monitoring traffic flows associated with a UE that terminate within the communications network; and providing an alert to a TAR.

In an embodiment, the monitoring function can be associated with a network slice provided by the communication network for use by the UE.

In an embodiment, the monitoring function can be instantiated at a location that allows it to monitor the traffic flows of the UEs.

In an embodiment, the method can further comprise an action of providing information about the traffic flows of the UEs to a charging function for billing.

In an embodiment, the method can further comprise receiving a request from the TAR function to control traffic and acting upon the request. In an embodiment, the request can be to adjust the traffic capability. In an embodiment, the request can be to add an additional subset to the guaranteed capability. In an embodiment, the request can be to restrict traffic flows according to a criterion supplied by the TAR function. In an embodiment, the criterion can be at least one of priority of the traffic flow, a time of transmission and/or receipt of the traffic flow, a location of a source and/or a destination of the traffic flow, the UE from which the traffic flow emanates and/or to which the traffic flow is directed, a service type associated with the traffic flow and allowing a traffic flow whose quality is compromised. In an embodiment, the TAR function can activate and/or deactivate UEs and/or traffic flows associated therewith in response to the alert.

In an embodiment, the communications network can provide a guarantee of a specified traffic capability for a subset of the UEs comprising a subset selected by at least one of time, geography and type of service and the action of monitoring can comprise determining that the traffic flows differ from the guaranteed capability by a pre-determined threshold and alerting the TAR function.

In an embodiment, the communications network can provide a guarantee of specified network resources and the action of monitoring can comprise determining that the traffic flows utilize resources that differ from the guaranteed resources by a pre-determined threshold and alerting the TAR function.

In an embodiment, the communications network can charge based upon the traffic flows of the UEs and the action of monitoring comprises measuring the traffic flows and alerting the TAR function of the measured traffic.

In an embodiment, the communications network can charge dynamically based on at least one of network loading, competitive environment, a location of the UE, a time of the traffic flow, a user-in-the-loop capability, a negotiated charging scheme and/or an auctioning scheme.

In an embodiment, the UEs can be associated with a customer of the service.

According to a second broad aspect of the present disclosure, there is disclosed a method for collecting information associated with use of a service provided by a communication network, comprising actions at a monitoring function, of: monitoring traffic flows associated with a UE that terminate within the communications network; and providing an alert to a TAR.

According to a third broad aspect of the present disclosure, there is disclosed a monitoring function comprising a processor and a non-transient memory. The non-transient memory is for storing instructions that, when executed by the processor, cause the monitoring function to perform actions for collecting information associated with use of a service provided by a communication network to UEs of a customer of the communication network, of: receiving bids during a bidding period from customers interested in obtaining access to the service; withholding access, by the UEs of each customer, to the service until after expiry of the bidding period; providing the service to a selected one of the customers based on the received bids; and monitoring traffic flows associated with the UEs of the selected customer that terminate within the communication network.

In an embodiment, the service can comprise access to a network slice of resources of the communication network.

In an embodiment, the service can be provided for a predetermined service period.

In an embodiment, the action of receiving bids can comprise providing an update to the customers of the bids received and soliciting additional bids during the bidding period.

According to a fourth broad aspect of the present disclosure, there is disclosed a method of collecting information associated with use of a service provided by a communication network to UEs of a customer of the communication network, comprising actions at a monitoring function, of: receiving bids during a bidding period from customers interested in obtaining access to the service; withholding access, by the UEs of each customer, to the service until after expiry of the bidding period; providing the service to a selected one of the customers based on the received bids; and monitoring traffic flows associated with the UEs of the selected customer that terminate within the communication network.

Embodiments have been described above in conjunction with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Some aspects and embodiments of the present disclosure may provide a method and apparatus for collecting information associated with use by a customer of a service provided by a communication network.

### BRIEF DESCRIPTION OF THE FIGURES

Further features and advantages of the present invention will become apparent from the following detailed description, taken in combination with the appended drawings, in which:

FIG. 1 illustrates a business process model based on the Enhanced Telecom Operations Map®, according to the prior art.

FIG. 2A schematically illustrates interacting entities according to embodiments of the charging and monitoring method and apparatus of the present invention.

FIG. 2B schematically illustrates further interactions associated with FIG. 2A.

FIG. 3 is a block diagram illustrating components of a charging and monitoring system according to an embodiment of the present invention.

FIG. 4 is a block diagram illustrating components of a charging and monitoring system according to an embodiment of the present invention.

FIG. 5 is a signalling diagram illustrating a charging and monitoring procedure according to an embodiment of the present invention.

FIG. 6A is a block diagram illustrating an embodiment of a system for VN customer charging.

FIG. 6B is a block diagram illustrating an embodiment of a reverse charging system for on-demand session charging.

FIG. 6C is a block diagram illustrating an embodiment of an on-demand session charging system that includes 3^{rd} party payment authorization.

FIG. 6D is a block diagram illustrating an embodiment of an on-demand session charging system that charging to an end user.

FIG. 7 illustrates interaction between a UE, a network operator and a customer service provider, according to embodiments of the present invention.

FIG. 8 illustrates operations related to charging adjustments provided in relation to adjustments to slice capability and/or QoE, according to embodiments of the present invention.

FIG. 9 illustrates operations related to charging adjustments provided in relation to adjustments to slice capability and/or QoE, according to other embodiments of the present invention.

FIGS. 10A and 10B illustrate network configurations for use in implementing bidding processes, according to embodiments of the present invention.

FIG. 11 illustrates operations related to a bidding process for services, according to embodiments of the present invention.

FIG. 12 illustrates operations related to tracking information related to UE operations, by a charging monitoring function, according to embodiments of the present invention.

FIG. 13 illustrates different possible UE access types which may result in different charging rates, according to embodiments of the present invention.

FIG. 14 illustrates operations supporting customized charging associated with data caching operations, according to embodiments of the present invention.

FIG. 15 illustrates operations supporting customized charging associated with data pre-fetching operations, according to embodiments of the present invention.

FIG. 16 illustrates operations supporting customized charging associated with context sharing services, according to embodiments of the present invention.

FIG. 17 is a block diagram of a computing system that may be used for implementing the devices and methods disclosed herein.

FIG. 18 is a flow chart illustrating an example of a method at a monitoring function for collecting information associated with use by a customer of a service provided by the network according to an example.

FIG. 19 is a flow chart illustrating an example of a method at a monitoring function of collecting information associated with use of a service provided by the network to UEs of a customer according to an example.

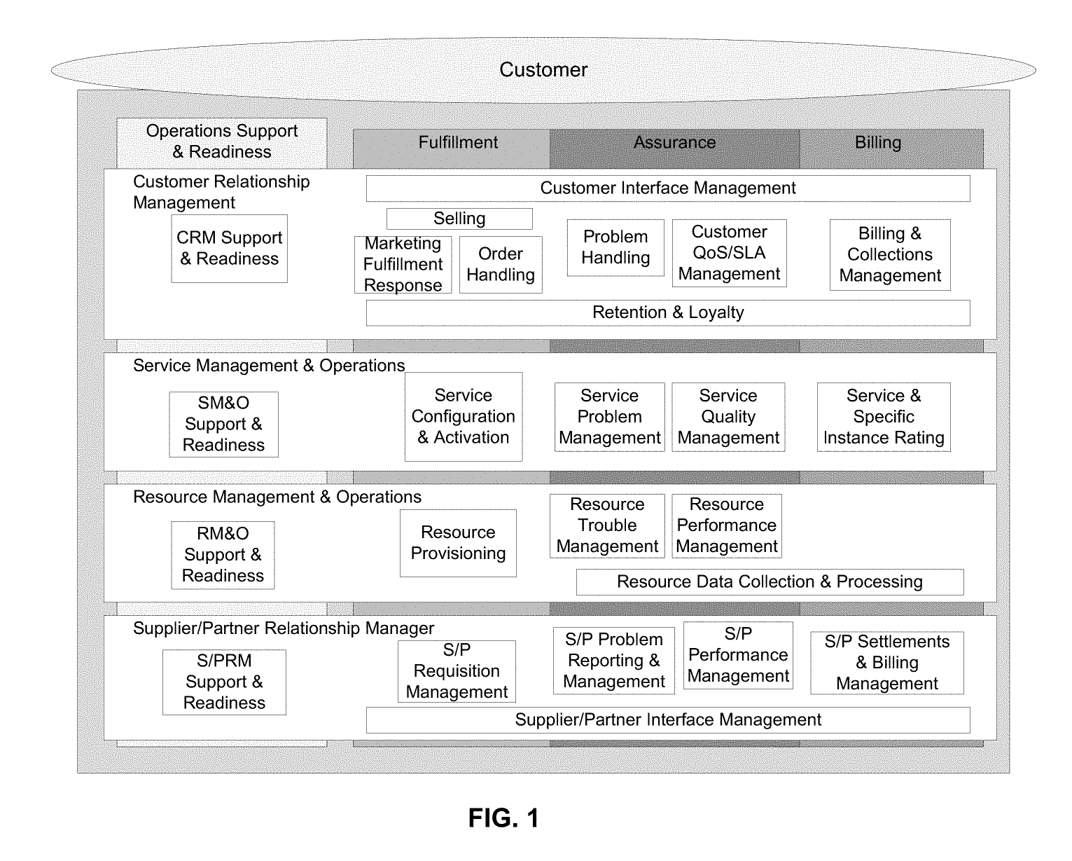

It will be noted that throughout the appended drawings, like features are identified by like reference numerals.

### DETAILED DESCRIPTION

Various acronyms as used herein are defined in the following non-exhaustive list:

AA: Authentication and Authorization

AAA: Authentication, Authorization and Accounting

BSS: Business Support System

CSM: Customer Service Management

CSPP: Customer Service Profiles and Policies

EPC: Evolved Packet Core

FPM: Financial Policy Manager

G-CSM: Global Customer Service Management

INB: Infra-structure Buyer

INS: Infra-structure Seller

KPI: Key Performance Indicator

MANO: Management and Orchestration

MNO: Mobile Network Operator

NFV: Network Function Virtualization

NM: Network Management

NPM: Network Performance Monitor

OSS: Operations Support System

QoE: Quality of Experience

QoS: Quality of Service

RAN: Radio Access Network

SDRA: Software Defined Resource Allocation

SDT: Software Defined Topology

SLA: Service Level Agreement

SN: Service Negotiator

TE: Traffic Engineering

UE: User Equipment

VIM: Virtual Infra-structure Manager

VN: Virtual Network

VNAC: Virtual Network Admission Control

VNF: Virtual Network Function

VNFM: Virtual Network Function Manager

As used herein, the terms Electronic Device (ED), “User Equipment” (UE) and “mobile device” are used to refer to one of a variety of devices, such as a consumer or machine-type device, which communicates with an access node via wireless communication. One skilled in the art will appreciate that a mobile device is a device designed to connect to a mobile network. This connection typically makes use of a wireless connection to an access node. An access node (AN) may be a base station, Wi-Fi access point, NodeB, evolved NodeB, gNodeB, or other device which provides a point of access to a backhaul network. Although the mobile network is designed to support mobility, it is not necessary that the mobile device itself be mobile. Some mobile devices, such as metering devices (e.g., smart meters) may not be capable of mobility, but still make use of the mobile network.

As used herein, a “network” or “communication network” or “mobile network” may provide communication services to various devices including but not necessarily limited to mobile devices. A mobile device can communicate with radio nodes using a protocol and have its data routed to a designated destination. Such a network may include a radio access portion and backhaul portion. The network may further comprise various virtualized components as will become readily apparent herein.

As used herein, Operations Support Systems refer to software (and sometimes hardware) systems that support back-office activities for operation of a network and provision of customer services.

As used herein, Business Support Systems refer to software applications that support customer-facing activities associated with a network, such as, but not limited to billing, order management, customer relationship management, and call centre automation.

Where 3G/4G networks relied upon network operators that owned the infrastructure that they relied upon, and typically provided service directly to subscribers associated with the UEs that connect to the infrastructure, next generation networks may have an architecture that permits the decoupling of roles in the network. A network operator (NO), or service provider (SP), not to be confused with a MVNO, may not directly own the entirety of the infrastructure that forms part of its network. Some the network resources, including access network resources, may be owned by an infrastructure provider or infrastructure owner. Access to these resources may not be exclusive, for example, more than one network operator may be provided access to the physical infrastructure of a set of so-called small cells within a building or set of buildings. In the context of billing, the infrastructure provider will need to be able to provide billing data to the NO in an agreed upon format, and on agreed upon terms (e.g. based on UE identifiers on a daily basis, or based on a categorization of type of UE on a weekly basis, etc. Each of these could be based on total amount of data consumed (or total uplink, or total downlink), or based on the number of transactions etc.) The NO may be providing access services for a Virtual Network Operation (VNO) that has the relationship with the subscriber. The NO may provide a network slice to the VNO containing the resources required to provide services to the subscribers. The NO can provide a VNO with a network slice within which the resources needed by the VNO can be instantiated The NO may also tailor the properties and attributes of the slice to the requirements of the VNO. The NO may also use slices to segregate traffic associated with different services. This can allow the No to create network slices that satisfy the needs of each of the specific services. In one such example a slice can be created to serve the needs of a Machine Type Communication service which can support a large number of devices, each of which generates small messages at fixed intervals. Latency and reliability of the transport layer of this slice is likely less important than it would be in a slice that supports Ultra-Reliable Low Latency Communications (URLLC), although he URLLC slice would typically needs to support fewer devices.

VNs are operated by VN operators (VNOs), such as mobile VNOs (MVNOs). A VN is typically created on top of the resources of a NO (and in some examples may rely upon the resources of more than one NO). Reference to a customer should be understood to refer to the relationship between a VNO and the NO from which is receives a resource allocation.

Where conventional 3G/4G networks have addressed the collection of charging information by tracking data traffic associated with a UE at the Packet Gateway (PGW) and Serving Gateway (SGW). The placement of traffic monitoring functions at the gateways allows an NO or MVNO to determine, on a per UE basis, how much data traffic crossed the RAN and Core Network. It should be understood that although the following discussion makes use of terms such as “charging” it could also be properly described as the collection of usage data. By focussing on the amount of data transmitted through gateway functions in a 3G/4G/network, the ability of a NO to have a flexible charging system is greatly limited. Charging data is collected on a per-UE basis, and there is little incentive for an NO to implement mechanisms that effectively reduce the traffic generated by as UE. For example, in a scenario in which a plurality of devices are sending messages to the same server, a NO has little incentive to provide an aggregation function that could reduce the amount of traffic leaving its network. Embodiments of the present invention address the mechanism that can be used to collect charging data in mobile networks. Many of the discussions presented below will provide mechanisms for an NO to collect data. The collected data can be aggregated in different ways and either used by an accounting function in the OSS/BSS of the NO, or it can be provided to an MVNO.

To supplement the conventional charging data collection embodiments of the present invention allow for the placement of monitoring functions at different locations of the network. The charging data collected by the monitoring functions can vary, so that one instance of a monitoring function can track the number of transactions, while another can track the volume of data. A single data flow associated with a UE may be monitored by more than one function. Services may be charged on a per-use basis (e.g. a per-transaction basis), based on traffic (e.g. a per-bit basis), etc. The collected charging data may also include information not used in 3G/4G networks. In addition to a time of day charging structure that is applied across a network, next generation networks may employ geographically differentiated charging. This may allow a network to charge more for data in a geographic region of the network that is particularly congested. To do this, the location of the UE, either in absolute terms, or in relation to the topology of the network would need to be included in the collected data. Furthermore, the time and traffic loads may need to be available to correlate to this charging record if not recorded in the charging data. If the UE location is based on a UE reported location, the placement of the monitoring function can be varied. If the location data is not based on, for example, a GPS location reported by the UE, then the placement of the charging function either at a basestation/access node or at an anchor point serving a plurality of basestations can be used to collect this information. To facilitate charging customization, charging data collection function (or a monitoring function) can be instantiated at a selected location in the core network in order to extract network activity information. This collected information can be provided to the OSS/BSS or to a customer for use in a given billing scenario. Charging can vary for example based on a geographic location of the network usage, traffic or congestion considerations, or time of day considerations, for example.

Embodiments of the present invention relate to 5G network charging operations, including monitoring, negotiation and interfacing aspects thereof, for one or more identified scenarios. Embodiments of the present invention relate to methods and apparatus for charging direct end users originating different types of on-demand communication sessions. Embodiments of the present invention provide for dynamic, potentially time-varying charging operations when communication quality (e.g. QoS) is compromised or enhanced. Embodiments of the present invention provide for charging operations which incorporate bidding actions. Embodiments of the present invention relate to charging operations which incorporate network monitoring.

Various charging principles for use in embodiments of the present invention in relation to 5G networks may be defined as follows.

In some embodiments, the entity being charged is a VN customer, an entity using a VN service, or an individual end user. Accordingly, charging data that is collected by a monitoring function can vary based on requirements defined by business processes and agreements. This data may also be aggregated in different ways based on these requirements.

In some embodiments, penalties may be described in a service level agreement (SLA) and invoked when an operator fails to meet certain key performance indicators (KPIs), such as network slice-level KPIs, VN service-level KPIs, and/or individual user KPIs.

In some embodiments, charging data collection/monitoring functions may be provided that are specific to a service and/or network slice. Different charging methods may be used for different user groups.

In some embodiments, collection of individual end user charging data may be provided to a VN customer in raw or aggregated fashions. To provide this charging support, the VN customer may be provided with access to a customer-specific charging data collection function which provides data for use by the VN customer in charging its end users. The mobile network operator (MNO) is not necessarily aware of the charging method being used by the VN customer.

In various embodiments, charging data may be collected to contain information associated with one or more of: usage of a bandwidth resource of the communication network; usage of a network-based resource; the number of transactions carried out; and usage of a specific service function provided in the network.

In some implementations, charges levied by a NO on a VNO (or by a VNO on the subscribers) for using an access network may differ from charges levied for using a backhaul network. Accordingly, the manner in which the data is collected, including the location at which the data is monitored for collection, and the information recorded during the collection, may vary. In various embodiments, charges levied for using an access network and/or backhaul network may differ based on geographic location at which the usage occurs. This may be the geographic location of the end mobile device receiving data according to the service, for example. For differential geographic access charges, the charging data collection function can be placed at a basestation, or at an anchor point associated with a set of basestations. This allows for definitive attribution of traffic in congested areas. In another embodiment, the charging function can be implemented at other locations, and UE specific location information (such as geographic location information provided by a UE-based function) can be recorded.

In various embodiments, particular charges may be levied for providing cached or stored, pre-fetched content. Charges levied for providing cached content may differ from charges levied for providing non-cached content, for example on a cost-per-byte basis. Because requests for data that are served out of a caching function in the network would not register as traffic leaving the core network, requests served out of the caching functions may not be properly attributable in a 3G/4G network. As noted above, by placing charging data collection functions to monitor access to cache data, charging data can be collected and either associated with the UE making the request, or with a content owner depending on the nature of the billing information.

In various embodiments, charges levied may differ based on service type. For example, charges may differ based on characteristics of data provided according to the service, such as QoS, reliability, bit rate delay guarantees, etc.

In various embodiments, charges may be levied for reserving a resource according to the service, whether or not the resource is used.

In various embodiments, the charging policy is negotiable between a customer, such as a VN customer, and network operators. The charging policy may be negotiable for example with respect to bit volume, communication delay parameters, and/or service reliability.

In some embodiments, charging rules may vary dynamically over time, and may be updated for example based on network load and/or network resource availability.

In some embodiments, charging rules may vary based on location(s) of end user device(s) and/or User-In-the-Loop (UIL), also referred to as UE-in-the-Loop.

In some embodiments, the collection of charging data is performed so that a service level agreement (SLA) model can be enforced for both parties. In the SLA model, pricing and charging rules are agreed upon. A customer service management (CSM) database can be used to indicate to charging data collection functions which data collection should be performed. A CSM can configure the location of a per-service CSM charging control element based on the manner in which the charging rules are applied.

In some embodiments, collection of charging data follows a per-pay-per-service model. In this model, the service price (charging rate) and charging rule are created based on negotiation between the CSM and a customer.

In various embodiments, charging data collection is included as one of several functionalities of automated customer service management, as provided within a mobile communication core network. The collection of charging data functionality can be integrated with various other functionalities of the CSM. Such other functionalities can include, but are not necessarily limited to collecting of charging data in accordance with: service negotiation and SLA creation; ensuring/validating QoE/QoS satisfaction; network functions used for caching and other services; policy control; resource assignment; user context handling; monitoring and feedback mechanisms; and customer billing.

The above functionalities can be provided using functions instantiated in the network, for example using network function virtualization. Such functions can be specific to a network slice. Such functions can alternatively be common functions located in a core network (CN) and/or a radio access network (RAN), and can service multiple network slices. A slice-specific function can be indicated herein using the prefix “S”, e.g. as in S-CSM. A common function (e.g. a function associated with a plurality of different slices, or a function that can be used to serve a plurality of different slices) can be indicated using the prefix “C”, e.g. as in C-CSM.

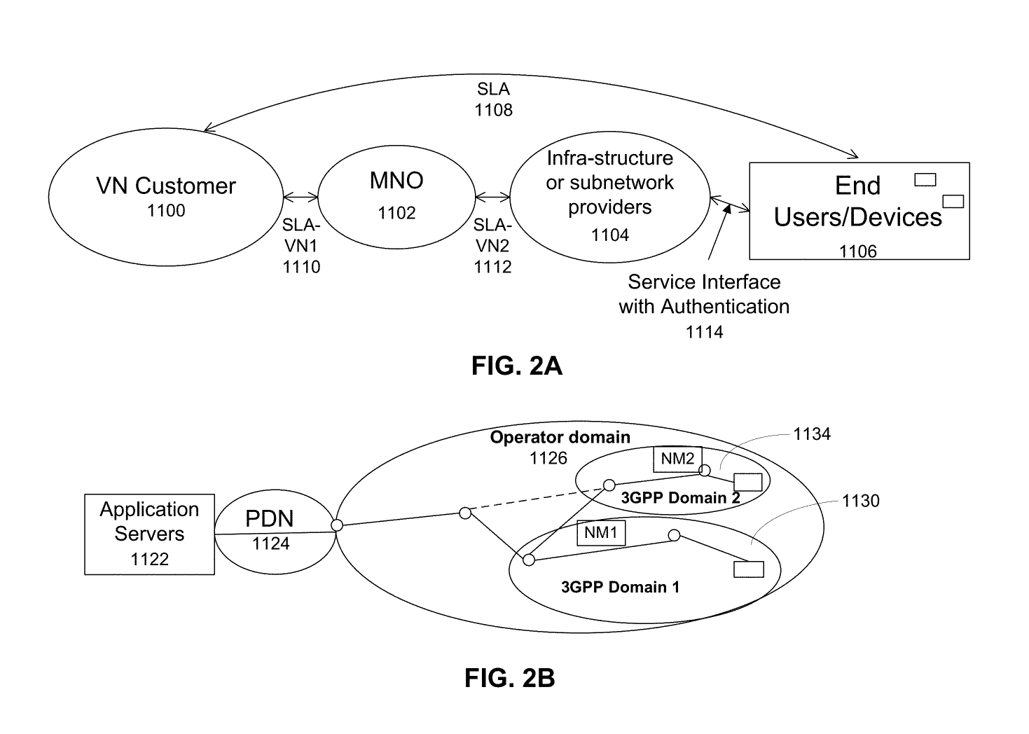

FIG. 2 illustrates interacting entities according to embodiments of the charging and monitoring method and apparatus of the present invention, for example in order to depict a business model thereof. As illustrated in FIG. 2A, each entity interaction may incorporate an SLA to be followed for charging of the respective entities. For example, as illustrated in FIG. 2A, a VN Customer 1100 (such as a VNO that is a customer of the MNO 1102) can have its VN created using the network resources of an MNO 1102. The MNO 1102 can perform charging data collection so that usage of resources of both the MNO 1102 and the infrastructure provider(s) 1104, can be attributed to the VN Customer 1100. The collection of charging data for will follow the SLA, referred to as SLA-VN1 1110, between MNO 1100 and VN Customer 1102. In addition, the VN Customer 1100 can interact directly with end devices 1106, with charging following another SLA 1108. The data collected by MNO 1102 and provided to VN Customer 1100 should be sufficiently details to allow the VN Customer 1100 to be able to satisfy the SLA 1108. The MNO 1102 can also interact with infra-structure and/or subnetwork providers 1104. The charging function between these entity types can be governed by SLA-VN2 1112. The infra-structure and/or subnetwork providers 1104, in turn, can interact directly with the end devices 1106. From the perspective of the end user, there is a relationship with VN Customer 1100 and the interactions with the infrastructure providers and MNO are transparent. Charging between these entities may proceed via a Service Interface 1114 with authentication requirements. The charging rules which have been agreed to will govern where and how charging data is collected, and how it is provided. When one entity provides service to another, the service can be provided according to a temporary or ongoing service level agreement. An entity can use its own resources in providing a service and/or acquire and re-sell usage of others' resources.

FIG. 2B illustrates a physical network layout which may be used to support the interaction of FIG. 2A. The layout includes application servers 1122 which are coupled to an operator domain 1126 via a packet data network 1124. The application servers may belong to the VN customer 1100, for example. The operator domain may belong to and be operated by the MNO 1102. One or more sub-domains 1130, 1134 are illustrated. At least one of these sub-domains 1130, 1134 may be operated by the infra-structure and/or subnetwork provider 1104. The sub-domains may be 3GPP domains, for example. The end devices 1106 can communicate with elements of the sub-domains 1130, 1134.

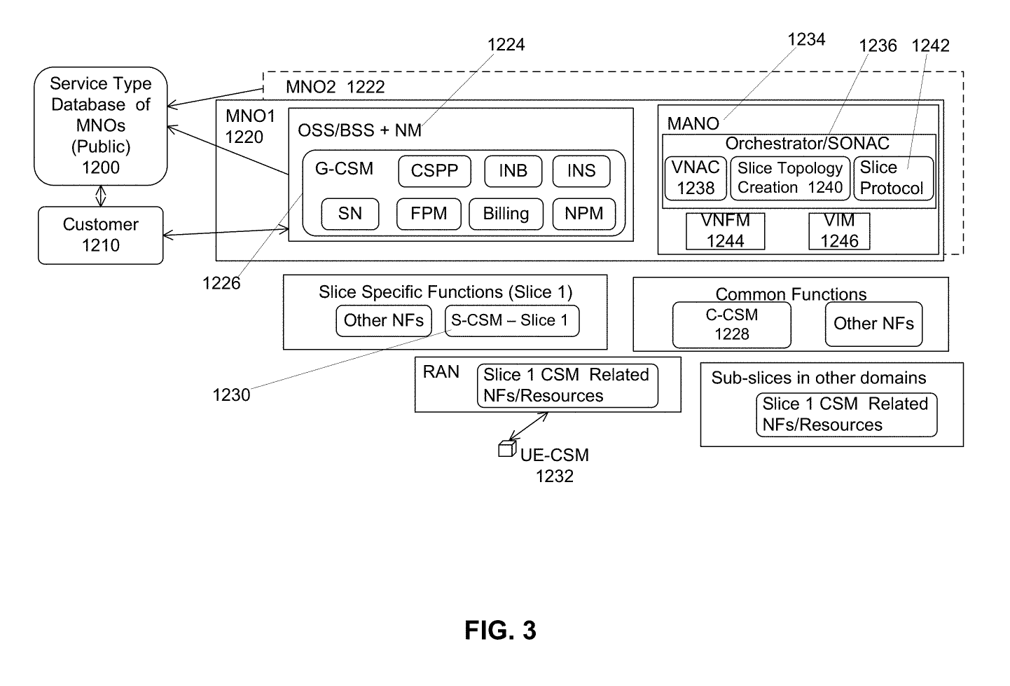

FIG. 3 is a block diagram illustrating a charging and customer service functional architecture according to one embodiment. As illustrated in FIG. 3, according to this embodiment, the system includes a public service provider information database 1200 listing MNOs. The database 1200 communicates with, and stores details relating to, at least one MNO and can be accessed by a customer 1210. In the example depicted in FIG. 3, the database 1200 includes details relating to at least MNO1 1220 and MNO2 1222. The database 1200 can include a listing of available services and service types, and associated parameters such as customer charging details, charging capabilities, available customization, etc.

The architecture includes different types of CSM functions. For example, MNO1 1220 includes a Global CSM (G-CSM) 1226, which functions as a component of within the OSS/BSS+NM system 1224, and works on management functions common to all the slices/services of the MNO1 1220. MNO1 1220 further includes MANO 1234, which comprises Orchestrator/SONAC 1236. As used herein, “SONAC” refers to a Service Oriented Network Auto Creation technology, which can be implemented as a set of network control functions or a software controller. In various embodiments, such as illustrated in FIG. 3, SONAC includes enabling technologies, such as VNAC 1238, Slice Topology Creation 1240, Slice Protocol function 1242, VNFM 1244 and VIM 1246. In embodiments where the network makes use of virtualization, such as is depicted in FIG. 3, some of these SONAC functions may reside in an orchestrator.

The charging and customer service functional architecture may additionally include Common CSM (C-CSM) 1228 functions in the control or user plane, which may be common to all the services/slices. Service/slice specific CSM functions (S-CSM), such as S-CSM—Slice 1 functions 1230 are specific to a single slice. A CSM function operating on the UE, labelled UE-CSM 1232 may be provided, for example in order to allow a UE, or user or owner thereof to interact with other CSM components in the network.

TABLE 1 shows certain examples of SLA parameters and associated requirements to monitor in the performance of the charging and customer service functional architecture.

TABLE 1

| SLA parameter | Example methods | Requirement |
|---|---|---|
| KPI guarantee for the | Monitoring of KPI for | If penalties are specified |
| e2E VN service/slice | the service at different | in SLA to address |
| (per geographical bin | geographical bis for time | variability, when close to |
| and/or time and/or | zones, specific user | violtaitons optimization |
| user category), e.g. | categories, etc. & trigger | needs to be done to |
| % users in | feedback signals to SOM. | decide what users/slice |
| outage/satisfaction | SOM according to | traffic (may be other |
| % area for a given | policy, SOM may take | the services) |
| QoE/outage stat | action (police traffic or | Monitoring, Policing, |
| % blocking for | block further sessions | Blocking, etc. points need |
| specific demand | from the same VN (may | to be decided for different |
| % dropping for | be based on geography/ | measurements, to reflect |
| specific demand | time and/or a priority | the geographical areas |
| | criterion), or contact VN | and different networks/ |
| | customer for instructions) | sub-networks. This needs |
| | | to be decided by the SOM |
| | | during creation. |
| | | If multiple services are |
| | | served by a single slice, |
| | | service specific data |
| | | collection, policing and |
| | | session blocking need to |
| | | be done by identifying |
| | | service traffic. |
| End-to-end per UE | If per user KPI drops, the | Per UE traffic need to be |
| KPI (e.g. aggregated | SOM get reported. SOM | identified at selected |
| data rate states for a | obtains other UE stats in | nodes. |
| UE for time zone, | the same area and try to | Dynamic priority |
| per Gbin, peak rate, | provide priority over | adjustment to address |
| latency, mobility | other users if possible | fairness as per SLA (e.g. |
| dependent | (to be fair, policing). It | scheduler) and charging |
| KPIs). | may instruct | and penalty policies |
| | sub-networks and nodes | The configuration change |
| | accordingly. | ability to do above |
| | | VN Customer may be |
| | | allowed to take a decision |
| | | Extra charges for close- |
| | | loop QoE management if |
| | | it is implemented |
| End to end per | Same actions as above is | Per session based |
| session QoE | possible (now against | identification |
| | other sessions) | Fairness across sessions |
| | | for each sub-network |
| | | VN Customer may be |
| | | allowed to take a decision |
| End to end per | Same actions as above | Per flow based |
| flow QoS | (now against other flows, | identification for a given |
| | but impact to session, per | session |
| | UE traffic need to be | Application/customer |
| | assessed) | may be consulted or |
| | | allowed to control traffic |

* Note:
In all cases, customer may request more resources or higher KPIs with higher charging to address overloading.

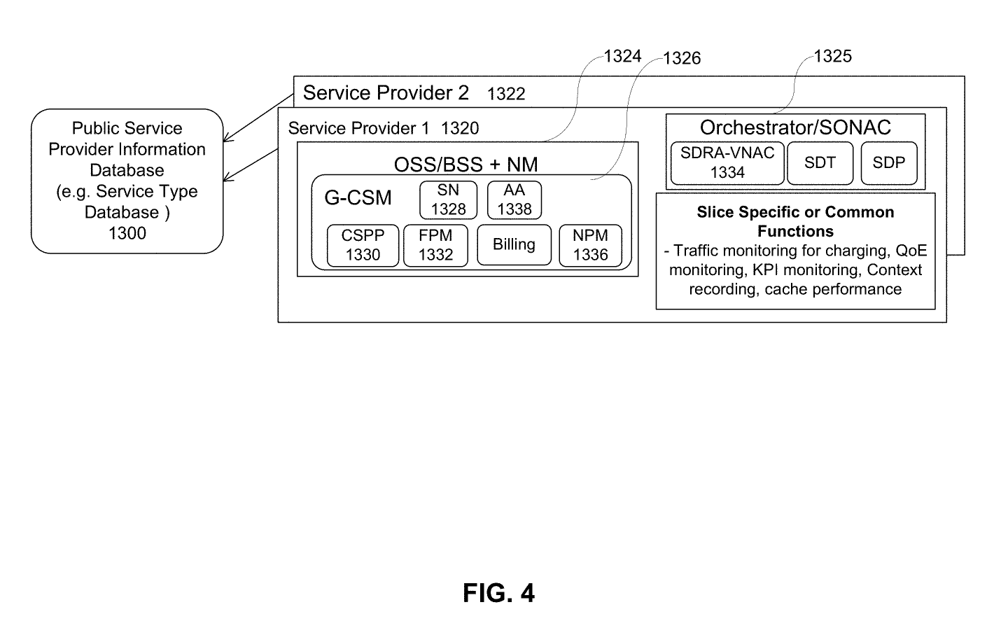

FIG. 4 is a block diagram of components within the architecture illustrated in FIG. 3, illustrating one embodiment of a system for customer charging operations, and the collection of the charging data.

Referring to FIG. 4, the Public Service Provider Information database 1300 maintains a listing of the offered service types of the service providers and associated policies and negotiation steps. The database 1300 further stores details associated with various charging methods. The details may include information about how the charging data is to be collected, and where the monitoring functions are to be instantiated. In the example illustrated in FIG. 4, the database maintains this information for at least Service Provider 1 1320 and Service Provider 2 1322.

Service Provider 1 1320, can include the following functionalities within the OSS/BSS+NM 1324 and the Orchestrator/SONAC 1325:
G-CSM (Global Customer Service Manager) 1326 consists of several CSM functions responsible for all the interactions with the customer during establishment of a new customer service. G-CSM functions may include preparation of the SLA, interaction with the orchestrator to obtain optimum solutions, network monitoring, SLA adjustments, and billing.
SN (Service Negotiator) 1328 is responsible for negotiation with a customer while obtaining capability assessment from VNAC and financial policies from FM.
CSPP (Customer Service Profiles and Policies) 1330 includes the service profiles of different (e.g. all) types offered by the network, and stores the SLA details including policy aspects once a service is admitted.
FPM (Financial Policy Manager) 1332 keeps the financial guidelines for business creation, optimization aspects for profitability and pricing, considering market situations and competition.
VNAC (Virtual Network Admission Control) 1334 assesses whether a service request can be accommodated, and assesses the associated resource cost. VNAC also indicates negotiation options (e.g., if extra resources are required).
NPM (Network Performance Monitor) 1336 stores the performance history of the network dynamically updated by the service instance monitoring functions. This is used to calculate the charges including penalties and to re-negotiate SLAs.
AA (Authentication and Authorization) 1338 negotiates the AA methods with the customer and stores customer device and service AA information as appropriate. The AA methods may depend on the charging method.
NM (Network management) configures and manages the slices and related functions, resources and databases required for the service.

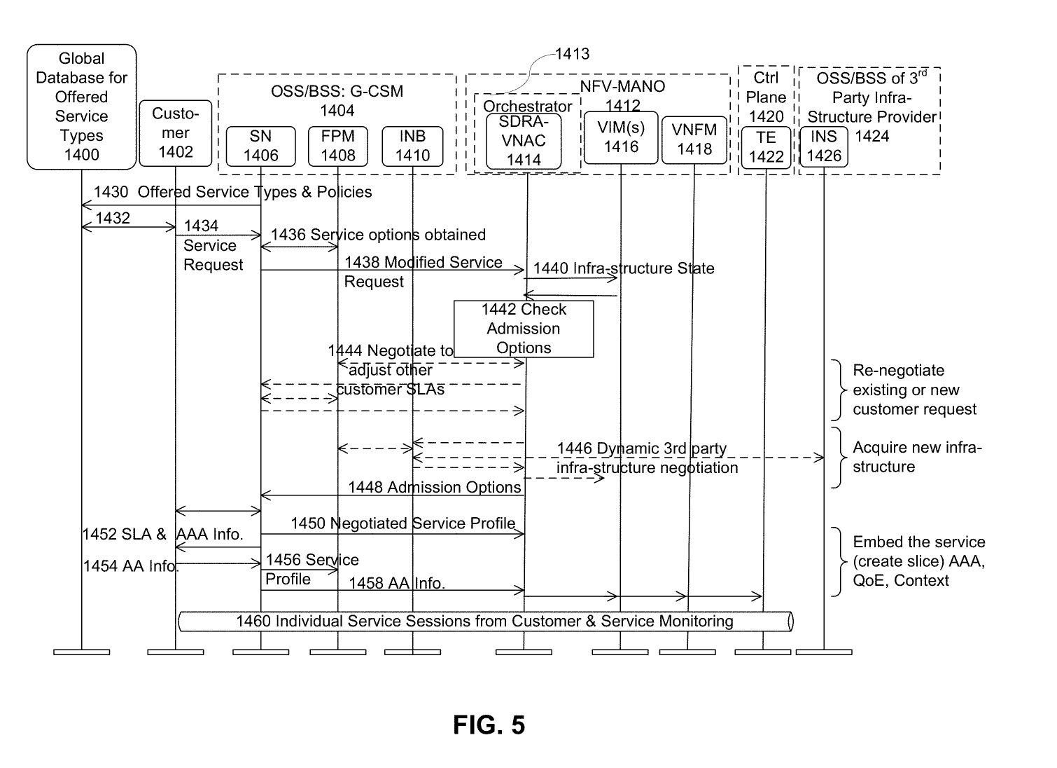

FIG. 5 is a signalling diagram illustrating steps of a procedure for 5G VN service provisioning and charging data collection. Operations illustrated in FIG. 5 are described below.

The first illustrated step 1430 is preparation of a public database 1400 for services offered by the network. During this step 1430 the G-CSM 1404 updates all the service types the operator can offer with the policies, coverage areas, traffic input methods, charging methods for public to view. In one example, the public database 1430 is a database comprising information related to multiple network operators.

In step 1432 the customer 1402 (or a representative device such as a UE or computer automatically operating on behalf thereof) makes a service request by reaching the database 1400 and attempting to find a matching service offer(s), following which, at step 1434, the customer (or representative device) makes a service request to interested network operator's Service Negotiator (SN) 1406 in the G-CSM 1404.

In step 1436 the service request is communicated to FPM 1408 and service options are obtained by the SN 1406 from FPM 1408 to generate a modified service request.

In step 1438 the modified service request is communicated to the SDRA-VNAC 1414 of the orchestrator 1413 of NFV-MANO 1412. In the next step 1440 the infra-structure state is communicated between the SDRA-VNAC 1414 and the VIM(s) 1416 within NFV-MANO 1412.

In step 1442 the SDRA-VNAC 1414 checks admission options. During this step a series of communications may be performed to re-negotiate existing SLAs or create new SLAs in response to the customer request. Optionally, in step 1444, SDRA-VNAC 1414 and SN 1406 negotiate to adjust other customer SLAs during step 1442. In optional step 1446 the INB 1410 of G-CSM 1404 communicates with the INS 1426 of OSS/BSS 1424 of a 3^{rd} Party Infra-structure provider to acquire a new infra-structure.

In step 1448 the SDRA-VNAC 1414 communicates the admission options to the SN 1406, following which, in step 1449 the SN 1406 communicates the options to the customer 1402.

In step 1450 SN 1406 communicates the negotiated service profile to the SDRA-VNAC 1414, and in step 1452, SN 1406 communicates the SLA and AAA information to the customer. In return, in step 1454, the customer (or representative device) 1402 returns the AA information to the SN 1406. Then the SN 1406, in step 1456, communicates the service profile to the FPM 1408 and, in step 1458, the SN 1406 communicates the AA information to the SDRA-VNAC 1414, which then forwards the information to the VIMs 1416, which forwards the information to the VNFM 1418. The VNFM 1418 then forwards the information to the TE entity 1422 in the control plane 1420 of the system. During these steps the service AAA, QoE and context is embedded (e.g., a slice is created).

In step 1460, the individual service sessions from Customer and Service Monitoring proceed.

Continuing now with a more general description of certain aspects of FIG. 5, in some embodiments, after the service request, the network negotiates the service provision. The G-CSM compares the service profiles and policies stored in the CSPP and if the G-CSM does not find a match with a service profile or several service profiles, it will either reject the request or re-negotiate a matching profile. If it finds a match, the request will be sent to the VNAC in the network design unit to check the admissibility or to provide options for further negotiation.

In some embodiments, after negotiation of the service provision, the VNAC checks admissibility, designs the best viable network solutions and informs the FPM in the G-CSM. The solutions may include, but are not limited to:
obtaining additional resources, in which the SN sends a request to the INB for the resources needed and if it can negotiate with an InP with the acceptable (profitable) price accepts the new call; and
reducing the requirements of existing services or the new request, in which the SN checks the best option out of the VNAC list and renegotiates with an existing customer or the new customer (or representative device thereof).

In some embodiments, the FPM jointly optimizes financial solution(s) with the viable network design options and the SN negotiates with the customer providing different options. If an agreement is reached, the SLA is established (or renegotiated as the case may be). The SLA can include, for example: how to perform AAA with the network operator (SN); required AAA information (e.g., device ID database, keys, capabilities, service types and priorities assigned to different devices.); service policies and KPIs; charging policies with required geographic and time zone definitions, and optionally where and how the charging data is to be collected.

In some embodiments, the MNO subsequently saves the SLA and informs the Network Design unit to create a service instance for this service. The MNO may define the customer service instance descriptor (CSID) and also choose a slice for the service and create or modify the network slice descriptor (NSLD) of the slice.

The CSID and NSLD include indications of methods usable to monitor traffic at different locations and other mechanisms to support above options as appropriate (e.g., traffic filtering methods, session admission control (AC)). The methods may be per-service based, per-user based, or per-session based. Accounting and other policies are maintained in the Global CSM-Charging (G-CSM-Charging) function. The policies may include traffic controlling or policing policies used to handle traffic/resource overload from end users/devices. The G-CSM decides the locations of CSM charging control and monitoring elements (e.g., types of data to log, bits, BW, location, etc.). The network management system (NMS) configures those charging related network functions, data forwarding and access resource assignment for QoS/QoE enforcement to network nodes and elements. The NMS also prepares a feedback mechanism for the QoS violations (e.g., triggering thresholds). The NMS can indicate charging changes in the case of dynamic charging and/or provide special charging related messages for service traffic control or for receipt by the customer. The NMS can also provide indications of customer service plan changes and changes to the above-described configurations to the accounting nodes.

Certain customers may have multiple service instances using the same slice instance. In one example, individual service instances are charged separately. In another example, charging is for use of the slice by aggregate services (e.g., prioritization, controlling admission of sessions or controlling generation of certain traffic types). The SLA may be customized to such situations.

In various embodiments, during operation (e.g. from time to time) or after completion of sessions or services, monitored information can be transmitted to the CSM. The CSM can compare actual performance profiles, determined based on the monitored information, with promised performance, which was previously agreed upon during service negotiation and/or acceptance of a SLA. The comparison can be used to prepare Bill/credit. For example, if delivered performance does not meet promised performance, an agreed-upon discount may be applied.

The method and apparatus as described herein may be used to support different VN service types. In one embodiment, the service type is an on-demand connectivity service provided in response to a direct end user request from an MNO. In this example, charging may be based on on-demand connectivity for a single session (which may include multiple devices) with no SLA. The single session may be provided directly to end users. An example of this type of service is a video conference for a one time session, with on-demand charging, reverse charging (to a third party), or free (no charge) basic service.

In another embodiment, charging is performed for a Virtual Network with end-to-end (e2e) service requirements for a VN customer having its own user/device population. In this case, the SLA may cover traffic demand distributed in different geographical bins/regions and specific times. This may be applicable to a single user with a SLA or VN customer with a SLA (its own service department can be considered as a VN customer). The following are three examples of a VN with e2e service requirements:
B1 Single slice single SLA, single vertical service;
B2 Single slice, multiple SLAs (e.g. for same application type (alarm services, video delivery services));
B3 Single slice, single SLA for multiple application types (e.g. having different QoE requirements) as a single aggregated service (e.g., multiple service instances for the virtual network slice with aggregate traffic cap). This may be applicable to an MVNO or a partner service provider.

In another embodiment the VN service is a VN with a specific topology. The VN has specific link/node capabilities (e.g., network, segment/sub-slice) and is provided either: (a) with control; or (b) without control. Such control may refer for example to resource, link, routing and/or scheduling control.

In another embodiment, the VN service belongs to an asset provider having specific resources (e.g., links, nodes, storage) or specific functions (e.g., virtual network function as a service (VNFaaS)). The VN service may be provided either: (a) with full controlling capability; or (b) without full controlling capability.

In another embodiment, the VN service is a special service, such as but not necessarily limited to a caching service, data pre-fetching service, or data analytics as a service (DaaS) service. In this case, related network functions may be instantiated using dedicated slices, or the related network functions may be instantiated in existing slices, with the cooperation of slice owners. For example, for a data analytics VN service, specific user or network information, or data analytics, may be provided to third parties (with consent of the network/end users).

There are at least three different types of customers that can be charged according to various embodiments. As such there are different locations for and types of data collection provided by embodiments of the present system and method. One type of customer is a VN customer. A second type of customer is an end user of an MNO's own VN service. The second type of customer may exist for example in the case that the MNO has its own MTC service and/or video distribution service which is available to customers thereof. As described in more detail below, the charging methods used for the VN customers is applicable to this case if the MNOs own application/service-providing department is its customer. A third customer type is on-demand end user sessions.

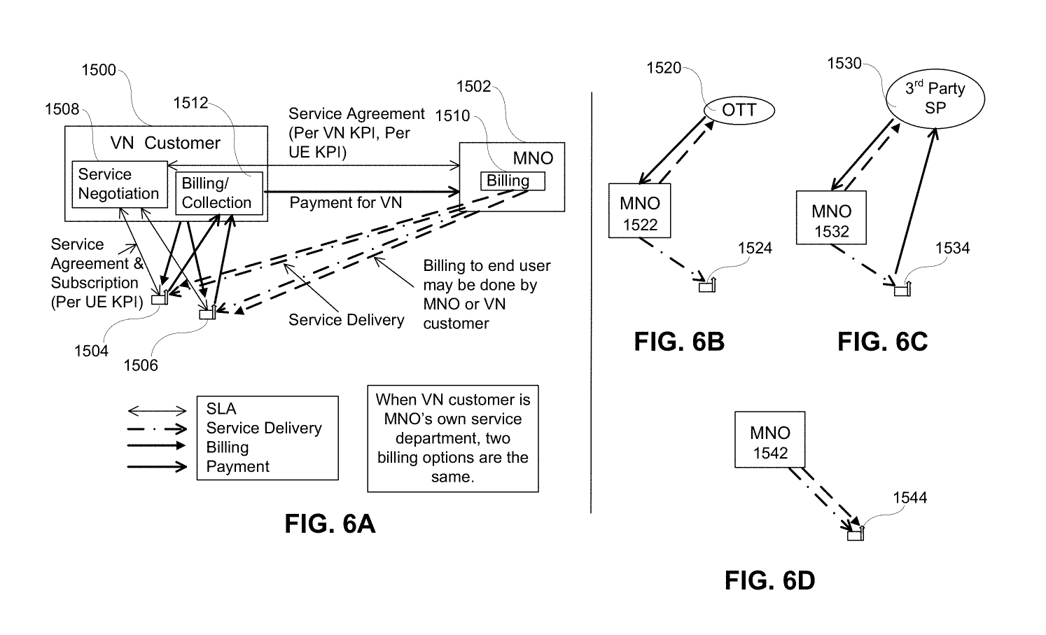

FIG. 6A illustrates an embodiment of a system architecture for VN customer charging. As illustrated in FIG. 6A, the VN customer 1500 is the MNO 1502's own service department, however, this system may also be applicable to the embodiment in which the customer is a VN customer. In the embodiment illustrated in FIG. 6A, end users 1504 and 1506 communicate with the SN 1508 of VN customer 1500 regarding SLA and subscription (including per UE KPIs). The SLA (per VN KPI and per UE KPI) is communicated between VN customer 1500 and MNO 1502. The MNO 1502 provides service delivery to end users 1504 and 1506. Either the billing entity 1510 of MNO 1502 or the billing/collection entity of the VN customer 1500 communicates with the end users 1504 and 1506 regarding billing. Payment is made from the end users 1504 and 1506 to the billing collection entity 1512 of the VN customer 1500.

FIGS. 6B-D illustrates examples of system architecture for on-demand session charging. As illustrated in FIG. 6B, the system architecture can support reverse charging in which an Over-the-top (OTT) entity 1520 delivers a service to an end user 1524 using an MNO 1522. In one embodiment, the service is generated using a function within the MNO. In this example, the MNO 1522 provides billing information to OTT entity 1520, which then provides payment to MNO 1522 for the service delivered to end user 1524.

FIG. 6C illustrates an example of on-demand session charging having 3^{rd} party payment authorization. In this example, the 3^{rd} party service provider 1530 delivers a service to the end user 1534 using the MNO 1532. Again, in one embodiment, the service is generated using a function within the MNO. Billing information is communicated from the MNO 1532 to the 3^{rd} party service provider 1530 and the 3^{rd} party service provider 1530 then provides payment to the MNO 1532 for the service delivered to end user 1534. The end user 1534 may provide payment to the service provider 1530.

FIG. 6D illustrates an example of on-demand session charging in which the charging is made directly to the end user 1544 from MNO 1542, which provides both the service delivery and the billing information to end user 1544.

The procedure for collecting charging data may vary based on the VN service provided, as described below.

In one embodiment, charging for the data consumed or for the transactions undertaken is directed to the VN Customer. As such, the data collection requirements can be configured to reflect this. This embodiment may be applicable, for example, for VN customers with specific e2e service requirements, VN customers requiring a specific topology, and for charging VN customers operating as asset providers.

In one example of this embodiment, charging may be based on a contract for a fixed demand. The contract may specify KPIs and/or may involve capability guarantee-based charging. The contract may include penalties for not meeting performance guarantees and may specify different charging methodologies for different geographical areas and time zones. The collection of charging data to satisfy these requirements would thus include information representative of the defined KPI requirements. Certain resources may be specified for different charging methodologies. In this example, the SLA may be long-term but the KPI may be for shorter-term or other-term temporal/geographical windows. For example, the contract may specify a monthly payment agreement for full VN service.

In another example, charging is resource reservation based. This may be used for charging for the use of network slices established using hard slicing and/or for charging based on the amount of resources reserved. Such charging may include penalties for not meeting a promised service requirement. This charging approach may also be applied for providing infra-structure as a service. As a result, the collected charging information might reflect the number of transactions that were satisfied vs. the number of transactions rejected. Alternatively the collected charging data would reflect the volume of data processed in the accepted transactions and the number of rejected transactions.

In another example, charging to a VN customer is usage based charging. For example, a first charge may be levied for access network usage and a second, possibly different charge may be levied for core network usage. Charging may be pay as you go, for example. Usage-based charging may be based for example on amount of generated traffic (e.g. number of sessions, bit volume) or based on an amount of resources used for serving the VN customer. The charging data collected would thus be usage based, but it could be reported to the VN customer on a very short reporting cycle so that the VN customer can accurately determine the data usage. The collected data could also reflect the time and location of the data connection along with network usage statistics to enable congestion based billing.

In a further example of charging to a VN customer, a dynamic charging procedure is used. In this example, charging may be based for example on one or more of: network demand, network load, competitive state, bidding for services, location, or UIL generated information.

In another embodiment, charging is made to the end user. This embodiment may be applicable for, for example, on-demand connectivity services, VNs with e2e service requirements, and VNs with a specific topology.

In this embodiment, charging performed may be according to end user service, with billing to the end user directly by MNO and payment obtained from a VN customer. Charging may be performed according to end user service and charged to a VN customer (e.g. in a sub-contract situation). Charging may also be performed by reverse charging the end user (e.g. although charging data is associated with the UE, the charging record is attributed to the content provider instead of the UE).

In one example of charging according to end user service, charging may be for free (to the end user) access to certain servers (e.g., for access to an OTT service provider such as Amazon). The usage records associated with this usage can be prevented from being attributed to the user. In another example, the charging is performed using a dynamic charging procedure, which may be, for example, demand/load based, competitive state, bidding, location, or UIL based. In such cases the collected data may include load and location information and may optionally include information indicative of user agreement through UIL processes.

In another embodiment, charging is levied for special services (e.g., caching, pre-fetching, DaaS). In this embodiment, charging data may be collected for use of special functions used for the service, for caching or pre-fetching services, or for tracking or providing user context and data analytics.

The charging data collection procedures as described herein may include generic traffic monitoring at different points in the network, along with an aggregation and reconciliation to create a unified traffic monitoring report. The procedures may vary based on, for example, what statistics are to be collected, what granularity is required, and/or the management methods used to guarantee QoS.

Usage/traffic statistics collected may include: bit volume; resource usage; number of sessions; geographical information (such as user location, node location; with, for example, hot spots in network usage, remote areas, and different node types charging differently); and time information. There may be different data collected at different locations in the network, with reconciliation performed by a further aggregation function.

Usage/traffic statistics may be collected with different granularity in different embodiments. In one embodiment, for individual session charging, only bit volume, number of sessions, and geographic information may be used. For other service types, monitoring may be done for the network optimization, admission control, to change demand based charging parameters, etc. Usage/traffic statistics may be, for example: flow based; session based; UE based (when multiple sessions from same user); service instance based; service type based; slice instance based; slice type based; and/or aggregated per QoS based.

The method and apparatus for collecting charging data that can be provided for use in customer charging operations as described herein can comprise generic QoE/QoS management methods, monitoring and accounting. The methods may vary depending on SLA parameters.

In one embodiment, the SLA includes a KPI guarantee parameter for a provided e2e VN service/slice. The KPI guarantee may be per geographical bin or/and time or/and user category. The KPI guarantee may indicate, for example: percent users in outage/satisfaction; percent area for a given QoE/outage statistic; percent blocking for specific demand; and/or percent dropping for specific demand. The KPI guarantee may specify minimum performance levels for such parameters.

In one example of this embodiment, monitoring data flows and connections to ensure that one or more KPIs for the service can be satisfied may be performed at locations corresponding to different geographical bins, for one or more specific user categories, etc. The collected data can be used by both charging processes, and by slice operations managers (SOM) which may be responsible for adjusting resource allocation to satisfy the KPIs. According to a predetermined policy, SOM may take an action, such as policing traffic or blocking further sessions from using the same VN. The action may be based on geographic, time and/or priority criteria. The action may involve contacting the VN customer for instructions.

In various embodiments, if penalties are specified in the SLA to address variability, then when KPIs are close to violation levels, the MNO may examine the available resources to determine if resource allocations should be modified. As part of an optimization process, it may be decided that resources will not be re-allocated, because the cost of reallocation exceeds any penalties. Monitoring, policing, blocking, etc. points may be determined for different measurements, to reflect the geographical areas and different networks/subnetworks. Such details may be determined by the SOM during creation. If multiple services are served by a single slice, service-specific data collection, policing and session blocking may be performed by identifying service traffic.

In another embodiment, the SLA includes end-to-end per-UE KPI parameters (e.g., aggregated data rate statistics for a UE for time zone, per Gbin, peak rate, latency, mobility dependent KPIs). If a per user KPI drops, the SOM is notified. The SOM may obtain other UE statistics in the same area and attempt to provide priority service to the user (over other users) if possible, and subject to fairness and policing considerations. The SOM may instruct subnetworks and nodes to act according to such attempts. These statistics may be based on the collected charging data.

According to some embodiments, per-UE traffic is identified at selected nodes. Further dynamic priority adjustment can be performed to address fairness as per SLA (e.g. scheduler) and charging and penalty policies. The method and apparatus may have the ability to undergo configuration changes to facilitate the above. The VN customer may be allowed to make a decision. Further, there may be extra charges for closed-loop QoE management services if these are implemented.

In another embodiment, the SLA includes an end-to-end per-session QoE parameter. If a per-session KPI drops, the SOM is notified. SOM obtains other session statistics in the same area and tries to provide priority if possible, and subject to fairness and policing considerations. SOM may instruct subnetworks and nodes accordingly.

The method and apparatus according to this embodiment may utilize per-session based identification and fairness across sessions for each subnetwork. As in the previous embodiments, the VN customer may be allowed to make a decision.

In another embodiment, the SLA includes an end-to-end per-flow QoS parameter. If a per-flow KPI drops, the SOM is notified. The SOM obtains other flow statistics in the same area and attempts to provide prioritization if possible, and subject to fairness and policing considerations. The SOM may instruct subnetworks and nodes accordingly. In this case, impacts to session and per-UE traffic may be assessed.

The method and apparatus according to this embodiment may use per-flow based identification for a given session. Applications and/or customers may also be consulted or allowed to control traffic. Customers may request additional resources or higher KPIs with higher charging, to address overloading.

According to some embodiments, charging modifications can be made by causing a charging rate to vary with respect to a promised and/or delivered QoE. For example, charging reductions can be provided through compromised or improved QoE. In another embodiment, a set of different charging rates may be used. Each of the rates in the set can be associated with a different QoS/QoE. A Charging Function may receive performance reports from a node or function within the control plane, and based on the volume of data traffic delivered, and the measured performance of the delivery, a charging rate can be selected. This allows a management plane charging function to vary the charging rate in accordance with the QoS/QoE provided to each flow. The CSP, or the UE, having access to a mapping between charging rates and QoS/QoE levels, may initiate a change to a different level of service. This may be based on a determination that costs should be controlled, or based on a determination that particular traffic is sufficiently important to pay more for.

According to some embodiments, customer traffic can be dynamically controlled in order to reduce charging. For example, customer traffic can be reduced in areas and/or at times of high charging. Customer traffic can be adjusted to avoid certain characteristics that are subject to higher charging levels. To reduce traffic, a number of different techniques can be employed. In one embodiment, traffic shaping can be applied, allowing the network to throttle the traffic for particular customers. This reduction in the transmission rates will reduce the effect of the customer traffic on the network. In other embodiments, UEs associated with the network can be directed to alternate connections (e.g. offloading traffic from the RAN to a WiFi access point). In embodiment in which the access network is virtualized, parts of the RAN can be removed from the network slice associated with the customer (or can be removed from the customer visibility). In some embodiments, where the network includes both macro-cells and small cells, the small cells (or a subset of the small cells) could be removed from the network slice associated with the customer. This would have the effect of reducing the traffic that can be generated by the UEs associated with the customer. In a further embodiment, UEs associated with the customer can be directed to reduce their traffic demands. Those skilled in the art will appreciate that other techniques can be used to adjust the traffic associated with a customer.

According to some embodiments, bidding is integrated with charging operations, such that different entities can bid for different services, and charging is adjusted according to the bidding process. Details of such embodiments are provided below.

According to some embodiments, charging for and/or incorporating User-In-the-Loop (UIL) (also referred to as UE-In-the-Loop) aspects is provided.

According to some embodiments, charging reductions can be made available (or provided) for less expensive access options. For example, a customer (or the UEs associated with the customer) can be offered Wi-Fi access as an alternative to RAN access at a reduced price.

According to some embodiments, customized charging can be provided for special functions, such as VNFaaS (virtual network functions as a service) functions. VNFaaS allows for the provision of different network services that would normally require the installation or instantiation of a dedicated function, within a virtual network (or a slice) associated with the customer. In some embodiments, in place of instantiating a network function for the slice, a (typically rarely used) function can be provided to the customer on a pay-per-use basis. The network service provider may already have access to a function that can be used in different slices, and this allows the network operator to charge the customer for usage of a service instead of usage of the associated resources.

According to some embodiments, customized charging can be provided for caching or data pre-fetching services. For such embodiments, one aspect relates to the trigger condition that is used for charging. In a conventional caching situation, content that has been requested by a UE is saved (cached) at different places in the path between the content source and the UE. In a sliced environment, the cache locations are resident within the network slice. In the pre-fetching scenario, the content is pushed to different places in the network slice before a user requests it. In some situations, the overlap may be significant. A UE may request content, which is cached in different spots along the path from the content source to the UE. The caching of this content may serve as a trigger to push the same content to different locations in the slice that are not along this particular path. Charging mechanisms may vary between slices, and/or between slice providers. Charging rates may vary across different slices, allowing a CSP to select a charging rate by directing traffic though a different NO slice.

According to some embodiments, customized charging can be provided for context sharing services.

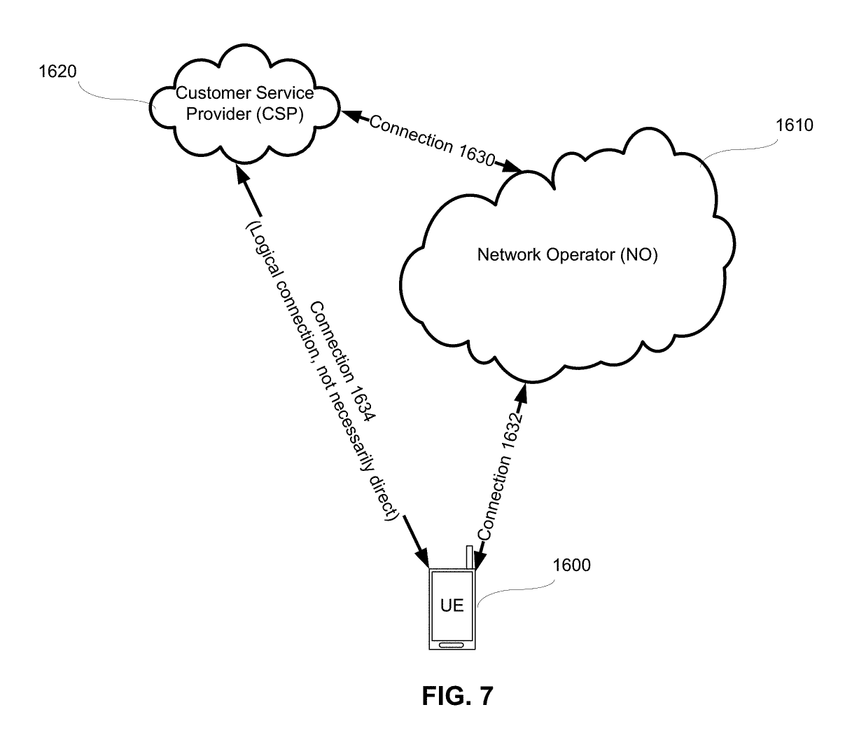

FIG. 7 illustrates interaction between a UE 1600, a network operator (NO) 1610 and a customer service provider (CSP) 1620, according to embodiments of the present invention. The CSP 1620 has a service management functionality which performs at least a portion (and in some embodiments all of) the negotiation between the NO 1610 and the UE 1600. The service management functionality may include charging, billing, quality controller, and/or application traffic controller sub-functions. The UE 1600 may have an application which operates, in response to received instructions, to control traffic related to the application. The UE application may prompt a user thereof to input operating instructions based on user decisions.

With respect to FIG. 7, the network includes service management functions which are configured to interact with the CSP 1620. Service management functions may interact with network management functions related to the network slice and/or service to instruct operations such as taking network measurements, making slice parameter changes, etc. Network management functions may control multiple domain managers, and all the instructions may be routed to individual domain mangers for execution (e.g., instructions for controlling sub-networks such as RAN, CN etc.).

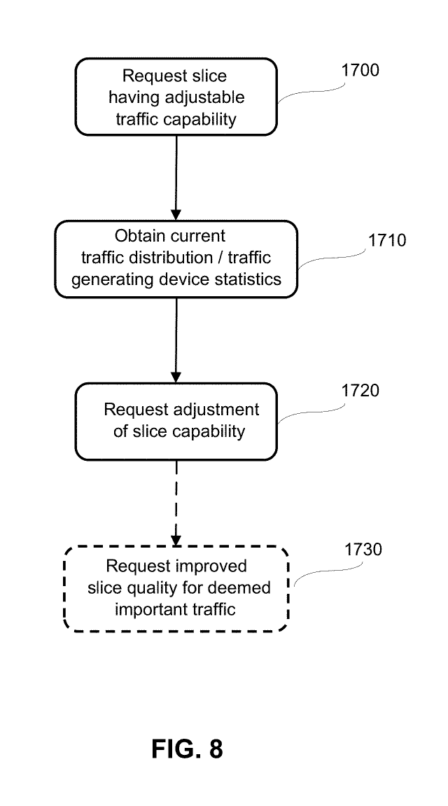

Embodiments of the present invention for which charging reductions are provided through compromised or improved QoE will now be described in more detail, with reference to FIGS. 7 and 8. As a first step 1700 a customer may request, or may have already requested, to be provided with a network slice that includes an adjustable network traffic capability. The network traffic capability associated with the slice can be adjusted according to at least one of the customer requirements and the available network capacity. Monetary costs incurred (e.g., by the customer) can vary with changes to the allocated network traffic capacity. In this way, the customer can lower the available network traffic capacity at certain times to reduce monetary costs. Network traffic capacity can refer for example to the capability of the network to handle an amount and/or rate of network traffic, for example due to the communication and computing resources allocated thereto.

In general, network slice parameters can be based on traffic, cost and other requirements. In the present case, a customer may request a slice that meets certain minimum requirements and/or which is dynamically adjustable to track these minimum requirements through time and/or location.

In establishing an arrangement with the NO 1610 to configure a network slice, the CSP 1620 typically provides some service parameters. This exchange of parameters (and possibly a negotiation over the acceptable terms) is carried out over connection 1630 as shown in FIG. 7. For slices that have dynamic configurations, the slice parameters can be dynamically adjusted by the NO 1610. These changes may be performed in response to receipt of an indication from the CSP 1620, but they could also be automated at the NO 1610 and the parameters would be adjusted in response to traffic on the slice (or in some cases in response to the overall traffic on the network in addition to traffic in the slice), dynamic changes in costs, and other service requirements. Effectively, the CSP 1620, during the initialization of the slice, thereby indicates its requirements, and requests a slice that dynamically adjusts itself to meet the indicated requirements, and which is not over-provisioned by more than a predetermined amount (e.g., percentage amount).

It should be understood that the configuration may also specify a threshold for any parameter (or any set of parameters) so that modifications that would leave the parameter within the threshold can be performed by the NO 1610 without confirmation from the CSP 1620. Further, any modification that would move the slice parameters outside the threshold could require a request for confirmation that would be sent over connection 1630.

In step 1710 the customer can obtain current traffic distribution and traffic generating device statistics. Obtaining these statistics can be used in the determination of a required network traffic capability. The current traffic distribution can be used as a metric that characterizes the load within the slice. The traffic distribution can be collected by the NO 1610 and provided to the CSP 1620 over connection 1630. The traffic generating device statistics can be collected by the NO 1610 over connection 1632, and submitted by the NO 1610 to the CSP 1620 over connection 1630. The traffic generation device statistics may include indications of how frequently UEs are attaching, a geographic distribution of UEs (possibly with an indication of how the traffic generation per UE is distributed as well); and a traffic profile for the UEs, such as the traffic load generated by: a UE in the bottom 5%; a UE in the top 5%, the average UE. In other embodiments, UEs can be grouped into classes so that information such as the frequency of UEs attaching can be provided based on the UE class. UE classes may be based on UE capabilities, or they may be based on other factors including the traffic load generated by the UE (on either a real-time or historical basis).

Next, in step 1720, the customer, knowing its end user requirements, sends a request to the NO 1610 to perform (or authorize) an adjustment to the capability of the network slice (e.g., the network traffic capability). The CSP 1620 may be able to anticipate changes to bandwidth or capacity demand on the slice based on the types of UEs that have registered (or based on a historical assessment of the resource consumption history of the subscribers associated with connected UEs), and may then adjust the slice parameters based on this information. For example, if the CSP 1620 is running a machine type communication slice, there may be different classes of UEs. Based on a triggering event (e.g., UE 1600 indicating that there is a problem) other UEs (e.g., other UEs in the same class, and possibly within a geographic distance from the UE 1600 that detects the triggering event) may be expected to increase their traffic demands. For example, if the CSP 1620 is an electricity provider, there may be different types of devices. A first class of devices may be the electricity meters connected to customer premises, while a second class of device may include sensors connected to the distribution equipment and is used to ensure the integrity of the distribution system. Typically, in the present example, there is very little traffic generated by the second class of sensor. However, if a problem is detected it is likely that other sensors in the area will issue reports based on cascading issues. Similarly, detection of an issue will likely result in an increase in downlink traffic as instructions are sent to devices at and near the point at which the problem is detected in an attempt to address the problem before it cause a cascading error. As a result, the customer, knowing its requirements may increase the capacity of a slice, in the area near a detected error so that the expected increase in traffic can be accommodated.

Furthermore, in step 1730, the customer may request, from the network operator, an increase in quality at certain times for important traffic. The dashed lines in FIG. 8 indicate that this step is optional. For example, this step 1730 may be required to obtain detailed pictures from video cameras in a given area. The increase in quality may correspond to an increase in network traffic capability. The requested increase may be temporary and localized to part of the network.

The above-mentioned “certain times” at which quality increases are requested can also apply to triggers. For example, in a security network, there may be devices such as sensors, cameras and bi-directional communication equipment. To save power, only 10% of the cameras may be active when there are no issues in the network, and the bandwidth associated with the bi-directional communication equipment may be provisioned to be small. However, if a protest is scheduled, or if a triggering event occurs (e.g., a camera detecting something of interest, or a sensor indicating that a window has been broken), the CSP 1620 may request an increase in the allocation of resources to the slice (possibly geographically based in some embodiments). In response, more, or all, cameras can become active, and the bi-directional communication equipment can be provided with sufficient bandwidth to allow proper communication. The trigger event may be detected by UEs and provided to the CSP 1620 over the connection 1634 (FIG. 7), which is shown as a logical connection and where the physical connection may go through an air interface to connect to a slice of the resources of the NO 1610 associated with the CSP 1620. The request for adjustment of resources is sent from the CSP 1620 to the NO 1610 over connection 1630.

In various embodiments, charging modifications (e.g. reductions) refer to a modification to the charging rates being applied. This may provide a mechanism that allows for the charging rate to be tied to QoE performance. Such embodiments may be based on an agreement between the CSP 1620 (also referred to as a Virtual Network Operator (VNO) and the NO 1610. The agreement can specify that different charging rates are applied when different QoE benchmarks are met. The CSP 1620 can then request QoE changes dynamically for some users in some areas and for some times, knowing the charges that will be associated with these parameters. The charging-to-QoE mapping may also be changed dynamically by the NO 1610. When the NO 1610 serves the UEs 1600 associated with the CSP 1620, the NO 1610 can adjust the allocation of resources to the UE 1600 to meet QoE levels that are determined by the differential charging levels and other demands on the network.

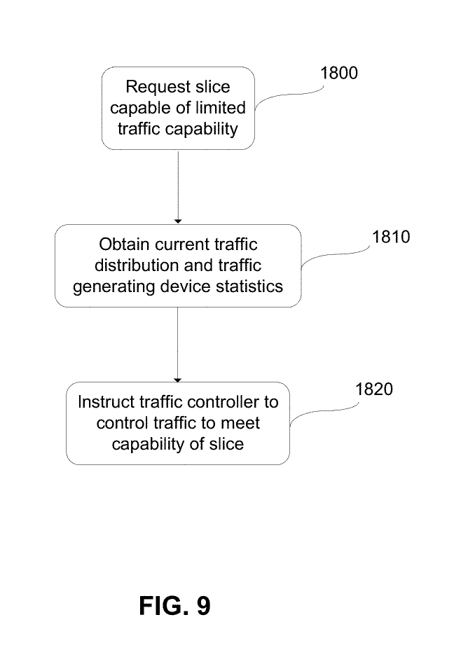

Charging reductions can be provided through compromised or improved QoE may be provided as follows, and with reference to FIGS. 7 and 9. First, at step 1800, a customer representative function may request a slice capable of limited network traffic capability, in order to pay a reduced cost relative to a slice with more capabilities. This is done initially, for example, to provide an indication to the CSP of the resources that it will require. Next, at step 1810, the customer representative function obtains a current traffic distribution and statistics for traffic generating device. As time goes on, the NO 1610 is able to gather usage statistics to provide to the CSP 1620 over connection 1630 (FIG. 7). At step 1820 customer representative function operates or has access to a traffic controller function operating in the network slice. The traffic controller instructs specific devices to control their traffic, in order to meet the traffic capability of the slice. The instructions can be configured in consideration of the customer's service priorities. In some embodiments, CSP-TE/RA decisions can be sent to UEs.

The traffic controller maybe a function within the network slice provided by the NO 1610. This function may be virtualized, or it may be provided by a physical traffic controller that has a portion of its resources allocated to the slice. Traffic Engineering, Resource Allocation, etc. type decisions can be sent to the UEs from the slice in a control plane.

For example, due to detection of a certain trigger, a large number of devices in a given area may have generated traffic, thereby creating congestion. In one embodiment, the devices may be MTC devices such as sensors that each transmit a report to an application server in response to detection of an event. The customer representative function may use a particular method, such as a polling method, to generate traffic for each device. The customer representative function may designate pre-classified user groups (e.g., group A, B, C, D). Then, the customer representative function can be configured to allow only one category of users to send traffic at a given time when congestion occurs.

Embodiments involving charging reductions provided through compromised or improved QoE may be used to address how a CSP's comfort with paying for different QoE levels along with network conditions can be used to shape traffic associated with UEs.

Those skilled in the art will appreciate that for communications associated with bidding, and other such mechanisms, a specific bidding slice may be provided by the provider of the resources that are being bid on. This slice may be accessed through and/or by entities in the management plane of both the CSP and the NO.

Some embodiments of the present invention in which bidding is incorporated with charging operations will now be described in more detail. Bidding can be used as a pricing negotiation tool between various entities, which in some embodiments may be operating automatically. Bidding can involve interaction between a network operator and a VN customer, interaction between a network and a UE (or end user), or interaction between a UE (end user) and a VN customer. Bidding can involve multiple consumers of a service competing for the service from a provider of that service. With reference to FIG. 7, the offer and acceptance messages of a bidding process can be carried out between the CSP 1620 and NO 1610 using connection 1630. It can be done between the network and the UE 1600 on connection 1632, or between the CSP 1620 and the UE 1600 on connection 1634.

Such embodiments can be based on the expectation of more than one CSP trying to use the resources of the NO 1610. By forcing an auction, or by increasing pricing during congestion at fixed intervals or specified intervals, the NO 1610 is configured to identify which CSPs are most interested in obtaining service. This may provide for a service distribution that takes into consideration the service valuations by the various CSPs.

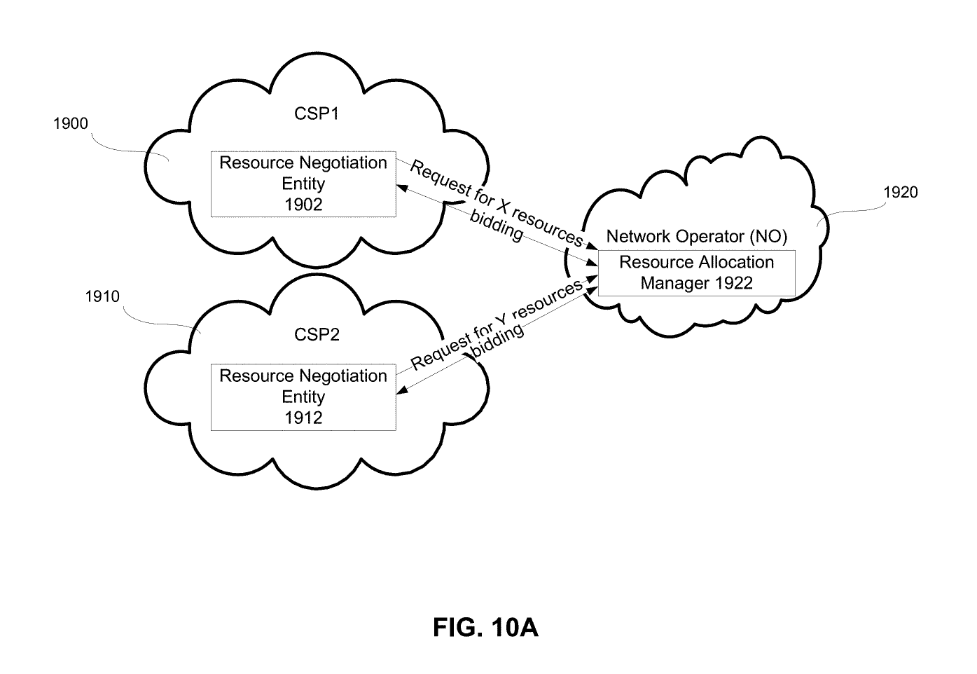

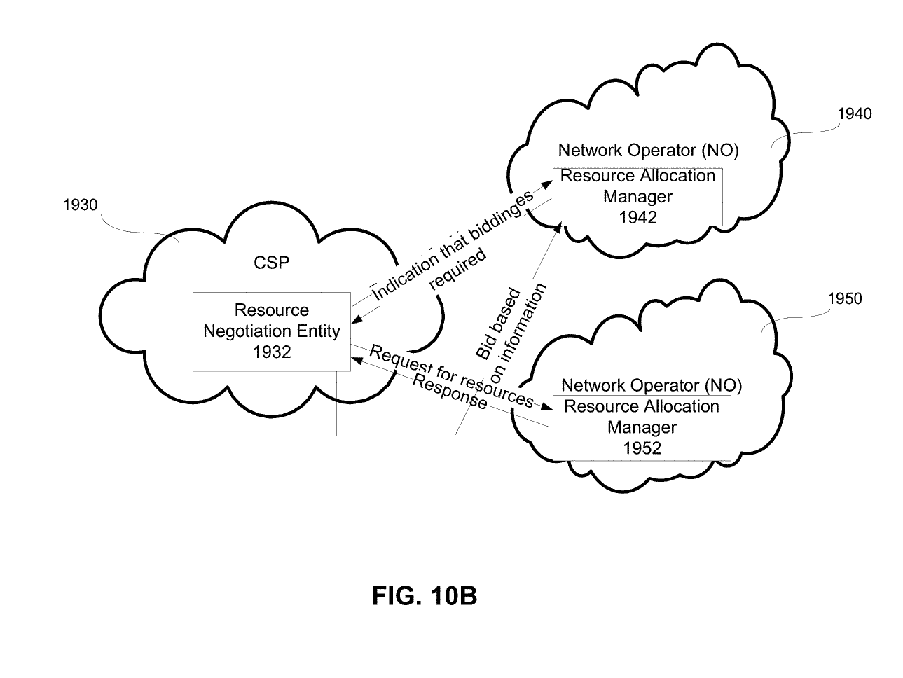

FIG. 10A illustrates an example embodiment for a bidding process in which two CSPs request resources from the same NO, and enter into a bidding process for such resources. The bidding process occurs between resource negotiation entities of the CSPs and a resource allocation manager of the NO.

Referring to FIG. 8A, as an example, when CSP1 1900 requests an allocation of a quantity X of particular resource (e.g. a reservation of bandwidth in a channel, or a reservation of a certain amount of storage or of processing capacity at a given node), and CSP2 1910 requests an allocation of a quantity Y of the same resource, the NO 1920 can determine that X+Y exceeds the available resources (these requests could be geographic in nature, in which case there would only be bidding on the resources in the region in which there is contention). A resource allocation management entity 1922 in the NO 1920 can determine that there are not sufficient resources to serve both requests. A bidding process can be undertaken for the contested resources. The bidding process can be carried out between the resource negotiation entities 1902 and 1912, of CSPs 1900 and 1910, respectively, and the resource allocation management entity 1922. It should be understood that in this process, it may be possible for either CSP1 1900 or CSP2 1910 to adjust the resource request. Each of the different types of bidding described herein as well as those that would be apparent to those skilled in the art can be supported.

FIG. 10B illustrates another example embodiment for a bidding process in which one CSP 1930 requests resources (e.g., conditionally) from two different NOs, NO 1940 and NO 1950. The CSP 1930 can enter into a bidding process for such resources with each NO 1940 and 1950. The bidding process can commence in response to an indication from an NO that bidding is required. The bidding process again occurs between resource negotiation entity 1932 of the CSP 1930 and resource allocation managers 1942 and 1952 of the NOs. The CSP 1930 can bid at both NO 1940 and 1950 and optionally drop a bid at one NO if more favorable terms are secured at the other.

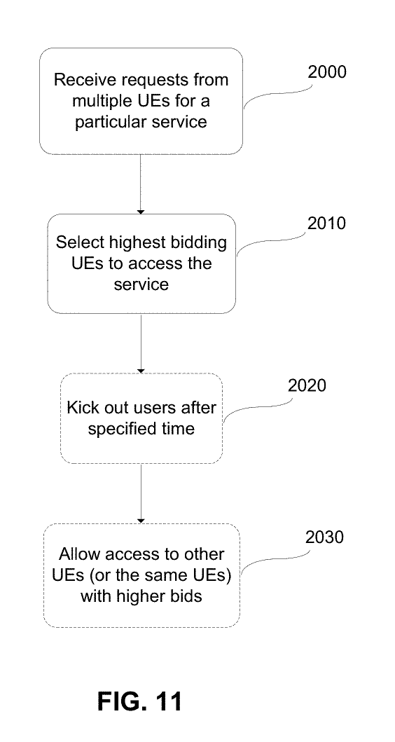

An example of a bidding process is described as follows, with reference to FIG. 11. At step 2000 UEs may send requests to an operator for a particular service to be provided for a given charging rate, and these requests are received. If the service is relevant to an important or popular event (e.g., live event or disaster), or the bidding process occurs at a peak service consumption time, a significant number of UEs may be requesting the service. The UE request for service can be handled by the CSP, or by the NO on behalf of the CSP. This can effectively provide congestion pricing incentives so that during events that create congestion, users will willingly (or UEs will automatically, based on user preferences) disconnect or reduce their service expectations. The changes in charging rate and charging rules can by dynamic until a desired effect is achieved.

At step 2010, in response to the UEs' requests, the operator (or CSP) may select a limited number of the UEs (e.g., the highest-bidding UEs) and commit (tentatively or fully) to providing the service to same. Other UEs may increase their bids, and those having higher bids may be provided with the service. One or several rounds of bidding may occur.

In some embodiments, the operator or CSP can select UEs based on bidding or need (or both). UEs can either offer a bid for service, or respond positively to an indication of a higher price. With each UE that accepts an offer for service, the subsequent offers can become more expensive. In one example, if a first UE is streaming a certain type of low-importance video at a large cost, they may be pre-empted by another UE requesting a more important service for a possibly lower costs (e.g., uploading images to an emergency service etc.) Penalties for disconnection may be agreed upon when agreeing to service as a part of SLA. The charging may be fixed for certain duration also agreed at the beginning.

In some optional embodiments (as indicated by the use of broken lines), such as is illustrated in step 2020 shown in FIG. 11, service offerings can expire after a predetermined time interval or other condition, such as after a predetermined number of messages being sent. The operator may define a set of services (and/or a set of conditions under which the services) are provided to a UE for a limited period. By terminating the provision of the service to the UEs that have obtained the service, and requiring the UEs that would like to continue using the service to re-transmit a request for service, possibly with a new bid for service, the UEs that have been denied the service may be provided an opportunity to obtain the service at a later point in time. It should be understood that although this dynamic has been described with respect to a UE and a CSP, the same interaction may be carried out between an NO and a CSP, so that the NO makes resources available for a time limited period and will require re-negotiation based on new network demands. This may be an initial term of service that allows the NO to specify that under conditions such as public emergencies or periods of excessively high demand, the initial agreement for rates can be adjusted optionally through a re-bidding process.

In some embodiments, either on a service-by-service basis or on a per-UE basis, a UE can be disconnected from the service after a successful bid (or after accepting an offer). This may result in the UE being disconnected from the network, or it may simply disconnect the UE from an additional service beyond basic connectivity. A disconnected UE can then be offered service again. This prevents a UE that accepted an offer early from indefinitely taking up resources when a different subscriber is willing to pay more for access to the service. In some embodiments, messages can be sent to a connected UE over a control plane connection without disrupting data plane service until the UE rejects an offer to continue service at a specified price. As indicated, the transmission of a revised offer for service with revised charging parameters can be done through a control plane, and disruption to traffic in the data plane can be done after the UE rejects an offer for service. In another embodiment, the revised offer for service can be sent through the user/data plane and may result in an interruption of traffic delivery. It should be understood that UE access to a service may be adjusted based on a demand for the service by prioritized UEs. In such an embodiment, after a first UE gains access to a service, it may be required to re-submit a request for that service after a period of time (or at the instigation of the network operator or CSP). This re-submission of requests for access allows prioritized UEs (such as those associated with emergency services) to gain access to resources without forcibly terminating the existing UE sessions. The prioritization of a UE may be associated with the number of previously obtained sessions. This can be used to increase or decrease the priority of a UE.

In step 2030, upon discontinuation of the service to some users, other users can be provided with the service if their bids are sufficiently high. In some embodiments, a previously served UE can retain or re-obtain the service if their bid is sufficiently high. Previously served UEs may be able to retain or re-obtain the service immediately or a service blackout period may be imposed on such users.

Having reference again to FIG. 10B, the CSP 1930 can issue its request for an allocation of a quantity X of a specified resource (as previously described). When the CSP 1930 receives an indication that bidding will be required from the NO 1940, it may contact a different NO 1950 to obtain information regarding the availability of the requested/required resource. Based on the response from the second NO 1950, the CSP 1930 can decide on how it wants to undertake the bidding process with one or both of the NOs with more complete knowledge. The CSP 1930 likely does not have information indicating the party that it is bidding against. Similarly an NO will likely not have knowledge of the pricing of available resources from another NO. In various embodiments, when the CSP is bidding, it should be understood that the CSP isn't necessarily bound to a single NO.

Embodiments of the present invention for which charging for and/or incorporating UIL aspects will now be described in more detail. In some such embodiments, the network operator provides, to the CSP, an indication of times during which, and locations at which, there is reduced charging for certain services (or alternately the NO provides the CSP with an indication of times and locations associated with changes in the charging rates). More generally, the CSP may be provided with an indication of relative charging levels as they vary with time and/or geographic location and/or network location.

In various embodiments, and with reference again to FIG. 7, the NO 1610 provides the CSP 1620 with time and location based charging rules on connection 1630. The CSP 1620 can use connection 1634 to provide time and location based charging rules to the UE 1600 (e.g., through a control plane interface). The UE 1600 can then decide when and how to connect to the NO 1610.

The charging rules forwarded by the CSP 1620 to the UE 1600 may be different than the rules issued by the NO 1610. If the CSP 1620 obtains services or resources from more than one NO, the CSP 1620 may generate a set of rules that differ based on which NO the UE 1600 connects to. This may result in changes to the geographic boundaries between different charging areas. There may be different rules associated with different access technologies. It should be understood that in some embodiments, the CSP 1620 may not provide charging rules to the UE 1600, and instead may make a decision for each UE, and then transmit a set of instructions to the UE 1600 defining when, where, and how the UE should connect. In some embodiments this may be done through the transmission of a System Information Block (SIB) type message. In some embodiments, the CSP 1620 may instruct a UE 1600 to not use a Radio Access Network during particular time window, and in a particular geographic region. This instruction may also include identification of Wi-Fi networks or access points that can be used in different geographic locations, or it may indicate a different Radio Access Network to be used. For any instruction like this that the CSP 1620 transmits, it should be understood that in some embodiments, the CSP 1620 could send a charging rule (or a set of charging rules) to the UE 1600, allowing the UE 1600 to make the same decision as the CSP 1620 would have otherwise sent as instructions.

Some such embodiments of the present invention allow one or both of the CSP 1620 and UE 1600 to make decisions about when, where, and how to connect. The issue of when to connect may be related to time of day pricing or congestion based pricing. Because different parts of the network make be loaded differently, it may be advantageous for a UE 1600 travelling on a known path to use one access network in some geographic regions, but not others. One example scenario is that of a UE 1600 travelling on a fixed path (e.g., a road, a predefined GPS route, or train track). If the CSP 1620 or UE 1600 is given a set of charging rules that indicate that as the UE 1600, which is using the network to stream a movie, moves through the center of a city pricing will increase, the UE 1600 may select to increase its local buffer size and start preloading content before it reaches the location at which pricing will increase.

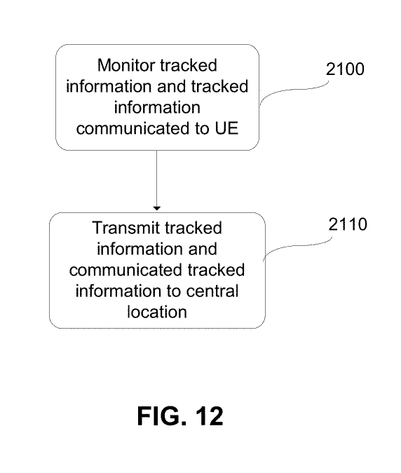

Additionally, as illustrated in FIG. 12, a charging monitoring function operating in the network can be configured to track, at step 2100, information including some or all of: session information, delivered quality, and originated location and time. Also tracked (e.g., by the charging monitoring functions) can be the charging levels indicated to the user for a given time, service and/or location. As such, the charging monitoring function may track the actual service usage and quality (e.g., QoS or QoE) of the connections provided to UEs associated with a CSP, along with associated time and location of service or resource usage, as well as the charging levels indicated to the user. Such information may be indicative of a UE session and used to facilitate geographic and time based billing. A charging function may be configured to record an indication that the UE has been provided with new charging rules (and optionally that the UE has acknowledged receipt).

In step 2110, the above tracked information, e.g., as obtained by the charging monitoring functions, is then provided to a processing function. In some embodiments, the processing function may be centralized. The charging levels indicated to the user may also be provided to the processing function. Charging is then evaluated at this processing function. Additionally or alternatively, a network charging function may evaluate the charging and send the evaluation information to the central processing function, along with the associated user information.

A centralized processing function may not necessarily be a single physical location. In some embodiments, the centralized function can refer to a logically centralized, but potentially physically distributed, function. In some embodiments, distributed data collection points can transmit the collected charging data to a distributed table or set of distributed data stores, which can all be accessed by a central billing entity or function.

Embodiments of the present invention relate to a CSP that can determine how a UE should implement the recommendations of the network, for example in addition to different monitoring schemes and message contents mentioned herein.

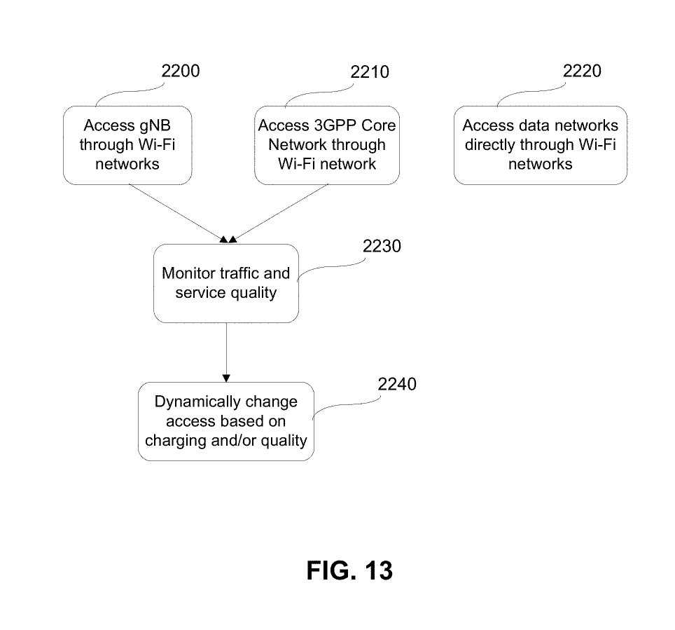

Embodiments of the present invention for which reductions in a charging rate are made available for less expensive access options (or access options that have excess capacity) will now be described in more detail, with reference to FIG. 13. A UE may have access to two (or more) types of access. In some embodiments this may take the form of access to two or more 3GPP access networks (e.g. more than one RAN through which the network can be accessed), or it may be access to a 3GPP RAN and a non-3GPP access network (e.g. Wi-Fi). Access types may include, for example: access 2200 to a gNB through Wi-Fi networks (e.g., in via LTE-WLAN Aggregation (LWA) or a successor aggregation technique); access 2210 through Wi-Fi networks to 3GPP Core Network functions without use of an eNB or gNB; and access 2220 through Wi-Fi networks directly to appropriate data networks (e.g. local breakout access).

In relation to some embodiments, it is noted that, in a multiRAT (multiple Radio Access Technology) environment, a UE can connect to a CSP slice using different RATs. A common scenario is to use the radio access network (e.g., LTE or a 5G radio interface), but this may be a highly desirable connection. LWA may be replaced by a comparable technology but of a subsequent generation. LWA allows an access point (gNodeB) to direct a UE to use a Wi-Fi connection for the data channel (also referred to as the user plane), while using a RAN connection for transmission of control signalling (e.g. for a control plane connection to the UE) This is one alternative to the 3GPP defined RAN access.

It is also noted that a UE may be able to connect to a Wi-Fi network to obtain access to packet data networks (e.g. internet access). The CSP can pre-program UEs with the information about how to access the CSP services over an Internet connection when they connect to a standard Wi-Fi hotspot. Some services such as voice calling and SMS can be supported this way through existing services. In other embodiments, when a UE approaches an area with sufficiently robust non-3GPP access services (such as reliable Wi-Fi connections) known to the CSP, the UE can be instructed to transition to a Wi-Fi connection, and be provided with instructions on how to access a network slice associated with the CSP from a Wi-Fi connection to the Internet.

In various embodiments, is anticipated that different wireless access technologies, such as Wi-Fi, will be common access technologies due to the prevalence of such connections, and the ability to use these access technologies to connect a UE to the CSP slice. In such embodiments, the RAN can be replaced by the non-3GPP access technology. Dual connectivity may be provided, which may depend on the charging abilities of non-3GPP networks, or the ability to provide a charging function with usage information from these non-3GPP access networks. For example, while a UE is roaming (e.g., out of a geographic coverage area of the CSP network slice), it might change a default access network preference, which may have (e.g. trigger) an associated change to charging rules.

Each of the different RATs and/or each of the different ways that the RATs are used, can be associated with different charging rules. The charging entities may thus be configured, in addition to recording how much traffic a UE generates, also record how may transactions are undertaken, when and where the UE is located, and the charging rules that were in place at the time of the connection. The type of RAT used may also be recorded. This allows differential pricing that accounts for the load on different access technologies.

In various embodiments, charging for the Wi-Fi access portion may be different from charging for 3GPP access. Such charging may be specified in collaboration with the Wi-Fi provider.

In various embodiments, monitoring 2230 of traffic, performance (e.g., QoS) and fault conditions may be performed. This may be performed in order to effectively monitor an amount of traffic and the service quality for individual links (i.e. 3GPP and non-3GPP links). Charging may be performed based on this monitoring.

Depending on relative charging options, the amount of traffic may be changed dynamically 2240. In addition, if charging varies depending on the user location (e.g., for UIL scenarios), the user may opt to send data in proportion to the amount of charging and/or in proportion to the quality.

In various embodiments, the UE may be executing an application that automatically performs load balancing and/or switching between two available systems. For example, a type of access via a Wi-Fi network may be selected dynamically based on charging information. Multiple types of access may be used concurrently, with different access types receiving different proportions of the user's traffic in accordance with a load balancing operation. The UE may also include a function that allows for scheduling of transmissions based on fore-knowledge of charging rates and the differences in rates based on time, location and/or access technology, and optionally based on fore-knowledge of UE mobility and route (e.g. knowledge of the UE location). Such a function may also be resident in the CSP and provide instructions to the UE to effect the same function. There may also be coordinating functions in the UE and CSP to effect this functionality. Such a function may allow for transmission of data for select applications or services and defer the access of other applications and services based on the above described factors.

In some embodiments, data with high QoS requirements may be sent via a more expensive path, while other data may be sent via a less expensive path. As such, selective transmission may be performed based on charging conditions.

In the case where data networks are accessed directly through Wi-Fi, there can be several ways to implement charging. For example, if a user (e.g., UE) is connected to multiple networks, selective transmission based on charging may be performed, for example automatically by the UE.

Embodiments of the present invention for which customized charging is provided for special functions, such as functions associated with VNFaaS implementations will now be described in more detail. It should be noted that the NFs don't have to be virtual for VNFaaS to work, however reference will be made to VNFs for the sake of clarity. A CSP request may be received which includes special functional requirements. These special functional requirements can include, for example, a specific data analytics function to be used, traffic handling functions to be used (e.g., including filtering, prioritization and/or slice/service management functions), etc. Charging may then be performed based at least partially on the special functional requirements being satisfied.

In some embodiments, different types of VNFs can be provided to the CSP, each with its own set of charging rules and rates. In a 3G/4G scenario, charging is typically done based on the volume of traffic associated with the UE that traverses gateways to the internet. In embodiments of the present invention, if an NO creates a VNF for a CSP, there can be different ways that the CSP is charged. The VNF may charge a fixed rate for a period of time. The charges could be on a per transaction basis (e.g., how many times was the VNF called upon to perform its function), a per session basis (e.g., how many different data sessions used the VNF to perform its function; this may allow multiple uses per session for the same cost), a per UE basis (e.g., how many times was the VNF function performed for a given UE within a given time window), by the volume of traffic that is handled by the VNF (e.g., a bit count), or a mix of these and other options. For example, there could be a fixed charge for using an authentication function on a per UE per session basis. In this case the UE may only need to be authenticated once per session, so the CSP will only be charged for authenticating a UE once per session, if the UE disconnects and reconnects the session is different and there could be a second charge. It should also be understood that if there are per transaction charges, there may be reduced charges for second transactions in a session, or per UE, etc.

In some embodiments, because instantiating a VNF consumes resources, there may be a charge for creating or accessing an associated function. Thus, if a CSP requests a function to be created, it could be charged for the instantiation and then charged on an ongoing basis simply for having the function available. The CSP can manage its costs by terminating the use of the VNF (e.g., by disconnecting from the VNFaaS). To mitigate the chance of a CSP using too many resources in the instantiation of the VNFs (or in the allocation of physical function resources), an initialization or allocation charge can be applied. The CSP can then determine when and if it is to instantiate and terminate functions within its slice. These charges can be in addition to any combination of the charging details as described above.

Furthermore, it is noted that functions used to satisfy the special functional requirements may themselves require specific amounts of resources to support their operation, such as amounts of CPU and/or data storage resources. As such, in various embodiments, the charging may be based on usage of such resources.

In various embodiments, the functions used to satisfy the special functional requirements may interact with other functions of the operator, for example using specific interfaces. Furthermore, communication establishment (e.g., to support this interaction) may involve satisfying transport requirements. As such, charging may be based at least in part on establishing such communication. In some cases, the functions used to satisfy the special functional requirements may require information such as dynamic network information and status. Charging may be based on the type of information being provided to these functions. In some cases, the functions used to satisfy the special functional requirements may include data analytic functions which operate using network information. As such, charging may be based on such data analytics and/or associated network information.

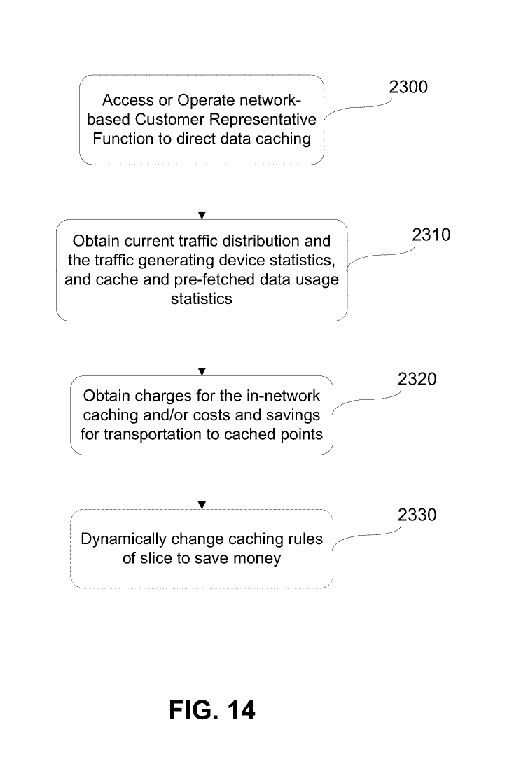

Embodiments of the present invention for which customized charging is provided for data pre-fetching services, which may be implemented within a specific slice, will now be described in more detail. In some embodiments, as illustrated in the example shown in FIG. 14, the following operations are performed in support of charging for caching of data. In step 2300, a customer operates or has access to a network-based customer representative function which is configured to determine parameters for directing the caching of customer data by certain network nodes. The parameters can include an amount of data to cache, a percentage of data to cache, and/or a policy for caching the data.

In step 2310 the function (or customer) then obtains some or all of: a current traffic distribution statistics, traffic generating device statistics, and cache and pre-fetched data usage statistics. This information may be specific to the slice that the function is resident within, but may contain an indication of such information in other slices, where the traffic information etc. associated with a different slice may have an impact on the charging in the slice within which the function is instantiated. Next, in step 2320, the function (or customer) then obtains the anticipated service charges for using in-network caching and/or the costs and savings for transporting data to the cached points. The function can determine a caching strategy which transports data using lower-cost options (e.g., involving geography, timing, network channels, etc.). Caching can thereby be used to deliver data in a cost-effective manner. Depending on the transport costs and storage costs and the other benefits of specific caching, at step 2330, the customer function can adjust its caching rules dynamically to save money. Note that the dashed lines in FIG. 14 indicate that this step 2330 is optional. The customer function can adaptively direct caching behaviours to deliver data economically given the charging variations in the network.

The customer function may also be made aware of certain content types that may be desired to be delivered to multiple devices of a network slice. The delivery may be desired to different devices at different times. The customer function may accordingly provide instructions to the network to cache those types of content over a longer period of time, so that the data can be delivered to the different devices as the appropriate times. This can facilitate a reduction in data transportation and associated cost. Caches can be used as staging points for providing data to multiple devices concurrently or at different times.

In various embodiments, the NO 1610 can inform the CSP 1620 (using connection 1630 illustrated in FIG. 7) where caching functions in the network exist. This can be provided as location information with respect to the topology of the network. The CSP 1620 can also get a mapping between access points (gNBs and Wi-Fi access points) and real world locations. The NO 1610 can inform the CSP 1620 about both the location of the cache functions and the charges for using them. Different caching functions can have different costs based on location and demand for caching at that location. The CSP 1620 can then determine when to cache, and where to cache (along with the decision of what data to cache) based on expected traffic, overall network demands, and the costs of both connectivity and caching.

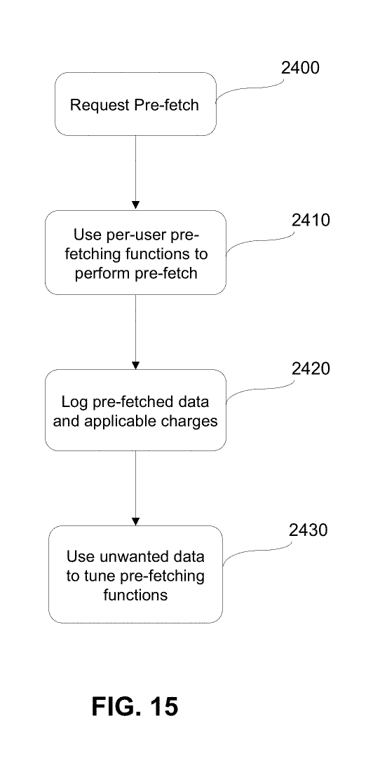

Embodiments of the present invention for which customized charging is provided for data pre-fetching services will now be described in more detail, with reference to the example provided in FIG. 15. In a first step 2400, a customer may request to apply data pre-fetching to its slice with the understanding that additional charging may apply. It is noted that data pre-fetching may improve customer satisfaction for certain type of applications depending on the cellular and other coverage the customer is using for its users. For example, pre-fetching may be used to guard against service interruptions or quality variations.

To support pre-fetching, the network or network slice may be configured to incorporate network functions that can determine the type of content the users are likely to be interested in, prior to this content being requested. To support this, in step 2410, per-user pre-fetching functions may be provided in the network. In some embodiments these pre-fetching functions may be part of a hierarchical distributed content delivery system. These functions may be synchronized with user-held content, e.g., content stored in a UE associated with a user. Content may be downloaded to UEs via other means (e.g., wireline plug in). The content already stored in the UE can be determined by the network function to reduce the content that needs to be stored in different caches in the network. As such, for example, the per-user pre-fetching functions may be configured to interact with the UEs to determine the content held in the UEs, so that pre-fetching of such content is avoided. The network functions (e.g., per-user pre-fetching functions) may be configured to operate particular algorithms in order to pre-fetch content, such as content that it is anticipated that the UE may request. It should be understood that pre-fetching functionality may be offered as a service to the CSP within its slice. This would allow control of prefetching and cache management as a service. In other embodiments, the function may be slice specific.

From a charging perspective, two types of additional costs may be associated with such a pre-fetching operation. A first type of additional cost is associated with pre-fetching of data (content) to the network edges. It is noted that some of this data might not be downloaded to the UE. A second type of additional cost is associated with pre-fetching data to the UE. It is noted that some of this data might not be used by the UE or user thereof. These additional costs can be borne by the content provider, the CSP or the individual end user associated with the UE (in some embodiments the costs may be shared between two of the three parties, borne by a single party or shared amongst all three. Alternatively, the network may charge an additional amount to provide this additional service, e.g. on the premise that it is expected to improve customer experience.

In various embodiments, such as are shown in FIG. 15, at step 2420, logs of pre-fetched data and the charges applicable based on the times and locations of pre-fetches may be recorded and used for charging purposes. In some embodiments, the unwanted user data (e.g. which is pre-fetched/downloaded but not used) may be used, in step 2430, as a quality measure of the pre-fetching scheme/functions so that those functions can be adjusted over time. Thus, a feedback loop can be used to reduce the difference between total pre-fetched data and pre-fetched data which is actually used.

It is noted that there can be many similarities between caching and pre-fetching. In effect caching is a determination that data requested by a UE should be stored closer to the radio edge so that another UE can access the data without having to go all the way back to the content source. In contrast, prefetching is a determination that data should be stored closer to the radio edge so that any UE requesting the data can access the content without having to go all the way back to the content source, the determination being made in anticipation of a UE request. For example, a video streaming service may push content towards the radio edge when it is first made available (or before it is available to the public) because there is an anticipation that this content will be in demand in different locations. The above embodiments of the present invention can inform how prefetching is be implemented within a network slice.

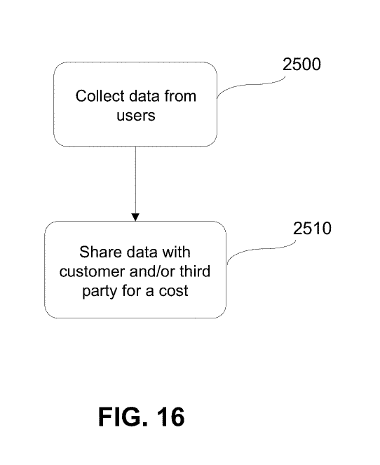

Embodiments of the present invention for which customized charging is provided for context sharing services will now be described in more detail, with reference to the example provided in FIG. 16. Initially, in step 2500, a network may collect different data from associated users and analyze the collected data with the permission of the end users and/or VN customers associated with such end users. In step 2510, this data may be shared with the customer or other 3rd parties, for a fee. Charging may depend on various functions which may also be involved in monitoring of certain data. Examples of data provided by such functions include: User location and signal level statistics; Mobility statistics; Service profiles of the user/locations; Certain behaviors of the users; Content interests of the users with locations and time; Environmental data through sensors; Network statistics; and data used to prepare wireless abstractions. Slice specific data may be analyzed and sent to the CSP associated with the slice. This allows Data Analytics to be offered as a service, or a function resident within the slice. If a CSP has provided authorization, the network operator may aggregate the data with other network measurements for use in overall analytics that may be provided to third parties (including a CSP associated with a different slice).

In various embodiments, monitoring functions configured to collect such data may be included in user devices, edge devices and/or in core network functions.

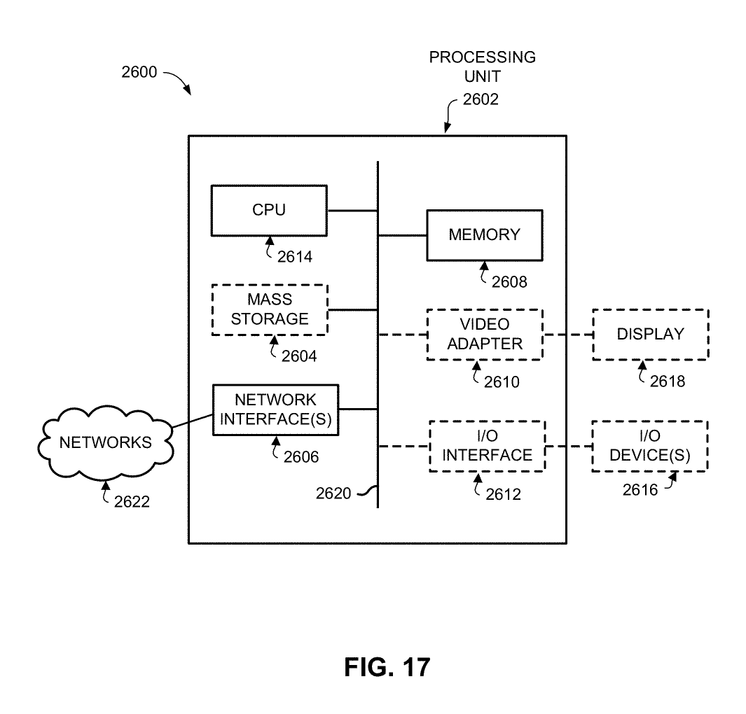

FIG. 17 is a block diagram of a computing system 2600 that may be used for implementing the devices and methods disclosed herein. Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 2600 includes a processing unit 2602. The processing unit 2602 typically includes a central processing unit (CPU) 2614, a bus 2620 and a memory 2608, and may optionally also include a mass storage device 2604, a video adapter 2610, and an I/O interface 2612 (shown in dashed lines).

The CPU 2614 may comprise any type of electronic data processor. The memory 2608 may comprise any type of non-transitory system memory such as static random access memory (SRAM), dynamic random access memory (DRAM), synchronous DRAM (SDRAM), read-only memory (ROM), or a combination thereof. In an embodiment, the memory 2608 may include ROM for use at boot-up, and DRAM for program and data storage for use while executing programs. The bus 2620 may be one or more of any type of several bus architectures including a memory bus or memory controller, a peripheral bus, or a video bus.

The mass storage 2604 may comprise any type of non-transitory storage device configured to store data, programs, and other information and to make the data, programs, and other information accessible via the bus 2620. The mass storage 2604 may comprise, for example, one or more of a solid state drive, hard disk drive, a magnetic disk drive, or an optical disk drive.

The video adapter 2610 and the I/O interface 2612 provide optional interfaces to couple external input and output devices to the processing unit 2602. Examples of input and output devices include a display 2618 coupled to the video adapter 2610 and an I/O device 2616 such as a touch-screen coupled to the I/O interface 2612. Other devices may be coupled to the processing unit 2602, and additional or fewer interfaces may be utilized. For example, a serial interface such as Universal Serial Bus (USB) (not shown) may be used to provide an interface for an external device.

The processing unit 2602 may also include one or more network interfaces 2606, which may comprise wired links, such as an Ethernet cable, and/or wireless links to access one or more networks 2622. The network interfaces 2606 allow the processing unit 2602 to communicate with remote entities via the networks 2622. For example, the network interfaces 2606 may provide wireless communication via one or more transmitters/transmit antennas and one or more receivers/receive antennas. In an embodiment, the processing unit 2602 is coupled to a local-area network or a wide-area network for data processing and communications with remote devices, such as other processing units, the Internet, or remote storage facilities.

Method Actions

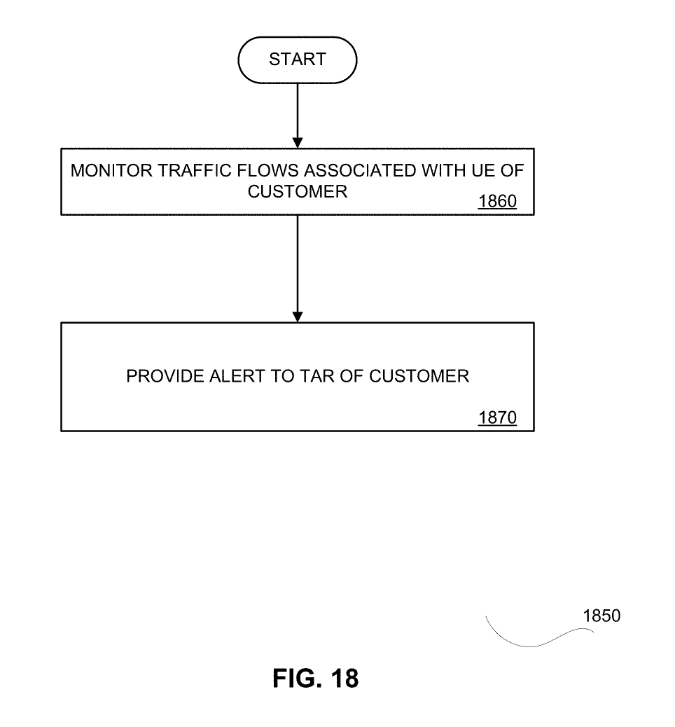

Referring now to FIG. 18, there is shown a flow chart, generally at 1850, of actions taken at a monitoring function, which may be the traffic controller, for collecting information associated with use by a customer of a service provided by a communication network.

One example action 1860 is to monitor traffic flows associated with a UE of the customer.

One example action 1870 is to provide an alert to a TAR of the customer.

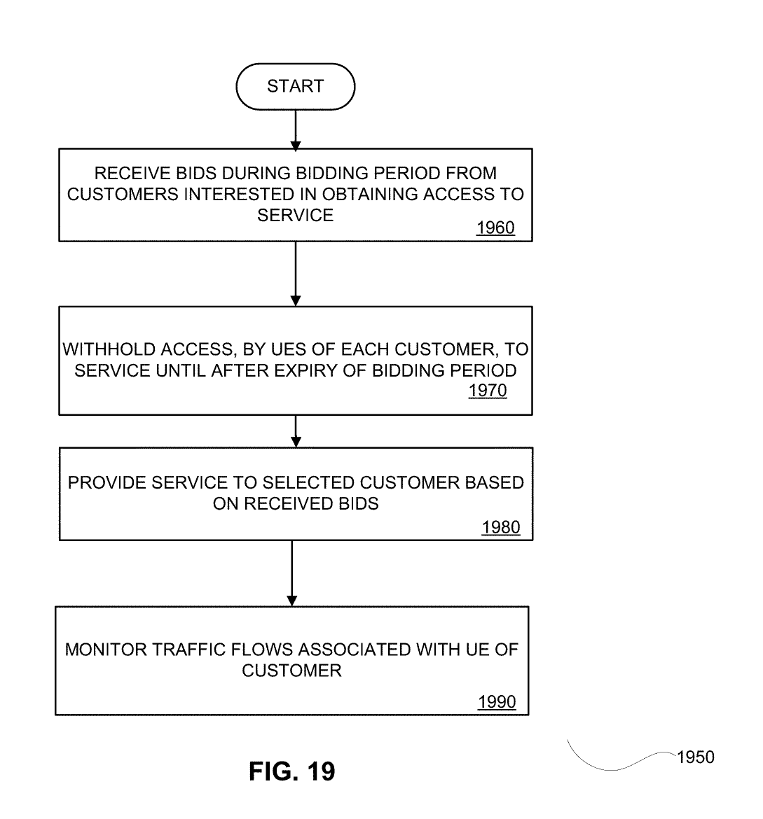

Referring now to FIG. 19, there is shown a flow chart, generally at 1950, of actions taken at a monitoring function, which may be the traffic controller, for collecting information associated with use of a service provided by a communication network.

One example action 1960 is to receive bids during a bidding period from customers interested in obtaining access to the service.

One example action 1970 is to withhold access, by the UEs of each customer, to the service until after expiry of the bidding period.

One example action 1980 is to provide the service to a selected one of the customers based on the received bids.

One example action 1950 is to monitor traffic flows associated with the UEs of the selected customer.

It will be readily understood that, throughout the preceding discussion, the above-described network functionalities and operations may correspond to a method for use in supporting operation of a communication network, such as but not limited to a 5^{th} generation wireless communication network. The method may involve computer-implemented functions, namely functions which are implemented by one or more computing, communication and/or memory devices of the network infrastructure. Further, it will be readily understood that embodiments of the present invention relate to a communication network system or associated apparatus thereof, which is configured to perform the above-described network functionalities and operations. Again, the system or apparatus may comprise one or more computing, communication and/or memory devices of the network infrastructure.

Embodiments of the present invention may be implemented using specific servers or general-purpose computing, communication and/or memory devices. Computing devices used to implement method operations may include a processor operatively coupled to memory, the memory providing instructions for execution by the processor to perform the method as described herein. Embodiments of the present invention may be implemented at least in part using computing devices such as Application Specific Integrated Circuits, microcontrollers, and digital logic circuits. Embodiments of the present invention may be directed to improving internal operations of the communication network.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

According to a first broad aspect of the present disclosure, there is disclosed a method for collecting charging information associated with a customer for use of a service offered in a communication network, the method comprising: instantiating a monitoring function at a location in the communication network, the location selected to allow monitoring or tracking of traffic flows associated with a UE and terminating within the communications network, the monitoring function configured to monitor said traffic flows and to provide indications of the traffic flows; and providing charging information for use in billing the customer based on the indications of the traffic flows.

In a first embodiment of the first aspect, the service can be provided via a network slice having an adjustable network traffic capability, and the method can further comprise receiving a request from the customer for adjusting the network traffic capability based on end user requirements known to the customer; and adjusting the network traffic capability in response to the request. In a embodiment, the method can further comprise receiving a series of requests from the customer over time for adjusting the network traffic capability; and performing a series of adjustments to the network traffic capability in response to the series of requests.

In a third embodiment embodiment of the first aspect and the first and second embodiments thereof, the service can be provided via a network slice having a limited network traffic capability, the method can further comprise: providing a traffic controller in the communication network, the network traffic controller configured to instruct devices, belonging to or served by the customer, to self-control operation so as to respect the limited network traffic capability.

In a fourth embodiment of the first aspect and the first to third embodiments thereof, the communication network can be capable of providing the service to a limited number of users, and wherein the method can further comprise selecting the limited number of end users from a larger number of end users via a bidding process.

In a fifth embodiment of the first aspect and the first to fourth embodiments thereof, the method can further comprise providing the customer an indication of variations in charging levels for the service with respect to time, location or both time and location. In a sixth embodiment of the fifth embodiment, the monitoring function can be configured to track some or all of: session information, delivered quality, location and time of customer service access, and the indications of variations in charging levels. In a seventh embodiment of the fifth and sixth embodiments, the method can further comprise making a determination of when to use the network based on the indication of variations in charging levels.

In an eighth embodiment of the first aspect and the first to seventh embodiments thereof the UE can have access to the service via two different types of wireless interface, wherein charging varies depending on usage of the two different types of wireless interface to access the service. In a ninth embodiment of the eighth embodiment thereof, the method can further comprise making a determination of how to use the two different types of wireless interface based on an indication of said variations in charging.

In a tenth embodiment of the first aspect and the first to and ninth embodiments thereof, the method can further comprise providing an additional function to satisfy functional requirements of the customer, and adjusting the charging information based on one or more of: provision of the additional function; resources used in communication with the additional function; and information provided to the additional function. In an eleventh embodiment of the tenth embodiment, the additional function can be one of: a data analytics function; a traffic handling function; and a network slice or service management function. In,a twelfth embodiment of the first aspect and the first eleventh embodiments thereof, the customer can use caching rules to cache data in selected nodes of the communication network, wherein customer charging varies based on time and/or location of data caching.

In a thirteenth embodiment of the first aspect and the first to twelfth embodiments thereof, the customer can use rules to pre-fetch data toward UEs via the communication network, wherein customer charging varies based on time and/or location of data pre-fetching.

In a fourteenth embodiment of the first aspect and the first to thirteenth embodiments thereof, the monitoring function can be configured to monitor user behaviour and to provide information based on said user data to the customer or to a third party.

According to a second broad aspect of the present disclosure, there is disclosed an apparatus comprising a network interface, a processor and a memory. The network interface is for communicating with connected nodes. The memory is for storing instructions that when executed by the processor cause the apparatus to carry out the method(s) of the first broad aspect.

Embodiments have been described above in conjunction with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A monitoring function, comprising:
a processor;
a non-transient memory for storing instructions that, when executed by the processor, cause the monitoring function to perform actions for collecting information associated with use of a service in the communication network, of:
monitoring traffic flows associated with a user equipment (UE) that terminate within the communications network; and
providing an alert to a traffic alert function (TAR).

2. The monitoring function according to claim 1, wherein the monitoring function is associated with a network slice provided by the communication network for use by the UE.

3. The monitoring function according to claim 1, wherein the monitoring function is instantiated at a location that allows it to monitor the traffic flows of the UEs.

4. The monitoring function according to claim 1, wherein the instructions further cause the monitoring function to perform an action of providing information about the traffic flows of the UEs to a charging function for billing.

5. The monitoring function according to claim 1, wherein the instructions further cause the monitoring function to perform an action of receiving a request from the TAR function to control traffic and acting upon the request.

6. The monitoring function according to claim 5, wherein the request is to adjust the traffic capability.

7. The monitoring function according to claim 5, wherein the request is to add an additional subset to the guaranteed capability.

8. The monitoring function according to claim 5, wherein the request is to restrict traffic flows according to a criterion supplied by the TAR function.

9. The monitoring function according to claim 8, wherein the criterion is at least one of priority of the traffic flow, a time of transmission and/or receipt of the traffic flow, a location of a source and/or a destination of the traffic flow, the UE from which the traffic flow emanates and/or to which the traffic flow is directed, a service type associated with the traffic flow and allowing a traffic flow whose quality is compromised.

10. The monitoring function according to claim 5, wherein the TAR function activates and/or deactivates UEs and/or traffic flows associated therewith in response to the alert.

11. The monitoring function according to claim 1, wherein the communications network provides a guarantee of a specified traffic capability for a subset of the UEs comprising a subset selected by at least one of time, geography and type of service and the action of monitoring comprises determining that the traffic flows differ from the guaranteed capability by a pre-determined threshold and alerting the TAR function.

12. The monitoring function according to claim 1, wherein the communications network provides a guarantee of specified network resources and the action of monitoring comprises determining that the traffic flows utilize resources that differ from the guaranteed resources by a pre-determined threshold and alerting the TAR function.

13. The monitoring function according to claim 1, wherein the communications network charges based upon the traffic flows of the UEs and the action of monitoring comprises measuring the traffic flows and alerting the TAR function of the measured traffic.

14. The monitoring function according to claim 1, wherein the communications network charges dynamically based on at least one of network loading, competitive environment, a location of the UE, a time of the traffic flow, a user-in-the-loop capability, a negotiated charging scheme and/or an auctioning scheme.

15. The monitoring function according to claim 1, wherein the UEs are associated with a customer of the service

16. A method for collecting information associated with use of a service provided by a communication network, comprising actions at a monitoring function, of:
monitoring traffic flows associated with a user equipment (UE) that terminate within the communications network; and
providing an alert to a traffic alert function (TAR).

17. A monitoring function, comprising:
a processor;
a non-transient memory for storing instructions that, when executed by the processor, cause the monitoring function to perform actions for collecting information associated with use of a service provided by a communication network to user equipments (UEs) of a customer of the communication network, of:
receiving bids during a bidding period from customers interested in obtaining access to the service;
withholding access, by the UEs of each customer, to the service until after expiry of the bidding period;
providing the service to a selected one of the customers based on the received bids; and
monitoring traffic flows associated with the UEs of the selected customer that terminate within the communication network.

18. The monitoring function according to claim 17, wherein the service comprises access to a network slice of resources of the communication network.

19. The monitoring function according to claim 17, wherein the service is provided for a predetermined service period.

20. The monitoring function according to claim 17, wherein the action of receiving bids comprises providing an update to the customers of the bids received and soliciting additional bids during the bidding period.
